(19) United States
(12) Patent Application Publication
(10) Pub. No.: US 2021/0188661 A1
(43) Pub. Date: Jun. 24, 2021

(54) Inverter wave generator for tempering water and method for tempering a tempering medium

(71) Applicant: ENAS AG, Herisau (CH)

(72) Inventor: Andreas Sgier, Eichberg (CH)

(73) Assignee: ENAS AG, Herisau (CH)

(21) Appl. No.: 17/271,226

(22) PCT Filed: Aug. 27, 2019
(86) PCT No.: PCT/EP2019/072883

§ 371 Date: Feb. 25, 2021

(30) Foreign Application Priority Data
Sep. 3, 2018 (DE) 10 2018 121 466.9

(51) Int. Cl. C02F 1/00; C02F 1/48; H05B 6/62; H05B 6/50; H05B 6/60

(52) U.S. Cl. CPC C02F 1/005; C02F 1/48; C02F 2301/026; H05B 6/50; H05B 6/60; H05B 6/62

(57) ABSTRACT

The present disclosure relates to an inverter wave generator for tempering a tempering medium comprising dipolar particles, having a housing with at least one inlet opening and at least one outlet opening for the tempering medium, at least one first electrode and at least one second electrode being arranged in the housing at a distance from one another, and the at least first electrode and the at least second electrode each being electrically conductively connected to a pole of at least one electrical signal source, the tempering medium having a conductivity in the range from 0.055 μS/cm to 500 μS/cm. Furthermore, the present invention relates to a method for tempering a tempering medium comprising dipolar particles.

### TECHNICAL FIELD

The present disclosure relates to an inverter wave generator having a cell for tempering a tempering medium comprising dipolar particles, and a housing having at least one inlet opening and at least one outlet opening for the tempering medium. Furthermore, the present disclosure comprises a method for tempering a tempering medium such as water.

### BACKGROUND

Electrical Conductivity of Water

Forces of an electric field on charged particles cause an electric current. This occurs in ionic fluids, formed for example by water with the addition of salts, acids or bases, in the form of moving ions.

Water has different conductivities depending on its purity. Electric current is transported by dissolved ions. Therefore, conductivity increases with increasing ion concentration. Pure water has extremely low conductivity. When salts, acids or bases are added, free-moving ions are released in aqueous solution. This causes the conductivity to increase.

In gases, solutions and electrolytes, the conductivity is temperature-dependent, since the mobility of the ions and the number of charge carriers generally increases with increasing temperature, which means that the mobility of the charge carriers increases with temperature and the electrical conductivity increases.

In water, the property of a base is manifested by the formation of OH− ions. At the same time, H₃O+ ions are formed in water, a property of an acid. A pH value indicates the concentration of H₃O+ ions in water. Pure water has a pH of 7 and is referred to as neutral. For the purposes of this disclosure, a pH range for water of 6.91 to 7.09 is assumed to be neutral, a pH range of 1 to 6.90 is assumed to be acidic, and a pH range of 7.1 to 14 is assumed to be basic.

Water consists of a collection of H₂O molecules. These water molecules are polarized, meaning they have different charges at different ends. One end is positively charged, the other negatively charged. The water molecule forms a well-known V-shaped electric dipole.

The different charge (positive and negative) causes attractive forces between neighboring water molecules, known as hydrogen bonds. They attract each other electrically. This leads to the agglomeration of many individual H₂O molecules into tiny clusters. Such clusters can consist of many hundreds to thousands of water molecules, and they each form their own arrangement. In a pattern, how the water molecules connect with each other and form clusters, the information content of the medium water manifests itself. Via swirling processes the cluster structure of the medium water can be changed informally by at least partial shifting or by dissolving the clusters. According to one research theory, the medium water has a memory and can transport information. According to this theory, a kind of “imprint” of substances and oscillations that have come into contact or have had an impact is stored in the medium water in a permanent to unstable manner.

This effect is known from homeopathic high potencies, which are supposed to still work even when the actual active ingredient has already been diluted to such an extent that it is no longer detectable materially. One therefore speaks in this context of “homeopathic water information”. According to this view, this information remaining in the water was stored by the corresponding substance through specific cluster formation in the water.

For the generation of heat energy from water (H₂O) a device is disclosed in the European patent specification EP 1 875 140 B1. EP 1 875 140 B1 relates to a heat generator for heating a fluid with a housing made of a dielectric material comprising a housing shell, a housing base and a housing cover with at least one inlet opening and at least one outlet opening for the fluid. The at least one anode and the at least one cathode are arranged in the housing at a distance from each other. The at least one anode and the at least one cathode are each electrically conductively connected to a pole of at least one pulse generator. A heating system comprises at least one conveying device for a first fluid, at least one heat generator for heating the fluid, at least one heat exchanger, in that the generated heat is transferred from the fluid to a further fluid, the use of the heat generator for heating a building, and a method for operating the heat generator for heating a fluid consisting of dipolar particles, such as molecules or molecular clusters, according to which the fluid in the heat generator is subjected to an electric field and, in the process, its particles are aligned according to their charge, the particles additionally being subjected to voltage pulses.

Furthermore, the patent specification U.S. Pat. No. 5,149,407 A describes a device in which water molecules are to be split into hydrogen and oxygen gas, whereby the gases are to be generated within a capacitive cell by a resonance process, depending on the dielectric properties of water and of water molecules.

As far as the applicant is aware, an economic efficiency of more than 100% has not yet been reliably reproduced. Furthermore, the publications mentioned, for example, do not disclose sufficiently concrete values for the parameters of the device and the process with which, as far as known so far, an economic efficiency could be reproduced, and which would have been commercially applied in this form.

It is therefore the object of the present disclosure to provide an improved device and an improved method for the temperature control of water, with which a reliably reproducible temperature control of a fluid medium is possible, whereby the energy delivered by the device and the method is higher than the energy fed into the device.

### SUMMARY

The present disclosure solves this object by an inverter wave generator for tempering a tempering medium comprising dipolar particles and a method for tempering a tempering medium comprising dipolar particles.

The Tempering Medium

The dipolar tempering medium used in the inverter wave generator is based on hydrogen bonds. The dipolar tempering medium is tempered in a cell of the inverter wave generator. The tempering medium comprises, for example, water, in particular advantageously specially prepared neutral water, which can optionally be enriched with additives. In connection with the inverter wave generator according to the invention, the water used by way of example is referred to as the tempering medium. In principle, other fluids with dipolar hydrogen bonding are also possible as tempering media.

The conductivity of the water used as the tempering medium has values in the range from 0.055 μS/cm to 200 S/m.

With low to medium conductivity of the tempering medium, mainly the stimulating effect of the electric field acts on the electric dipoles of the tempering medium, while an electric ion current does not or only slightly take place.

With increasing medium to high conductivity of the tempering medium, in addition to the stimulating effect of the electric field on the electric dipoles, a stimulating effect of the ions rubbing against the clusters of the tempering medium in motion takes place and the strength of the ion current increases. Thereby, especially in the case of a unipolar alignment of the polarity of the electric field without an alternation of polarity, an increasing gas formation occurs at the electrodes of the cell.

Depending on the embodiment of the inverter wave generator device according to the invention, a largely gas-free temperature control or a temperature control with more or less gas formation is alternatively achieved.

In synergy with further parameters according to the invention, the invention has alternatively and in principle the following embodiments of the value ranges for the electrical conductivity of the tempering medium:

Largely Gas-Free Temperature Control

For largely gas-free tempering of the tempering medium, a defined conductivity is readjusted by changing the conductivity in the tempering medium via a conductivity metering pump and exchange device, in that in a primary circuit the tempering medium is at least partially drawn off and/or water with a conductivity of 0.055 μS/cm to 500 μS/cm, in particular 0, 1 μS/cm to 100 μS/cm and preferably 10 μS/cm to 50 μS/cm, is supplied from tank containers suitable for these fluids or from a treatment device, each of which is arranged outside the device of the inverter wave generator, values of 20 μS/cm to 30 μS/cm having proved to be particularly advantageous in synergy with further parameters according to the invention.

Optionally, for largely gas-free tempering of the tempering medium by changing the pH value in the tempering medium, a defined pH value can be readjusted via a metering pump by at least partially drawing off tempering medium in the primary circuit carrying the tempering medium and/or supplying neutral water with a pH value of 6.91 to 7.09 from a suitable tank container arranged outside the device of the inverter wave generator or from a treatment device.

This embodiment advantageously utilizes the stimulating effect of the electric field on the electric dipoles.

Tempering Under More or Less Strong Gas Formation

Optionally, for temperature control of the tempering medium with more or less strong gas formation, a defined conductivity can be readjusted via the conductivity dosing pump and the exchange device by changing the conductivity in the tempering medium, in that tempering medium is at least partially extracted in the primary circuit and/or water with a conductivity in the range from 0.05 S/m to 200 S/m, in particular 0.05 S/m to 5 S/m and preferably 0.05 S/m to 0.5 S/m is supplied from tank containers suitable for these fluids, each arranged outside the device of the inverter wave generator.

Optionally, a defined pH value is readjusted via a dosing pump for temperature control of the tempering medium with more or less strong gas formation by changing the pH value in the tempering medium, by at least partially drawing off tempering medium in the primary circuit and/or supplying neutral water with a pH value of 6.91 to 7.09 and/or acid with a pH value of 1 to 6.90 and/or caustic solution with a pH value of 7.1 to 14 from tank containers arranged in each case outside the device of the inverter wave generator and suitable for these fluids.

This embodiment advantageously utilizes, in addition to the stimulating effect of the electric field on the electric dipoles, the stimulating effect of the ions rubbing against the clusters of the temperature control medium as they move. Furthermore, with the strength of the ion current, increasing gas formation at the electrodes of the cell can advantageously be used to generate energy by recombining the gas back into water in the cell, in the primary circuit or in a separate part of the primary circuit, and feeding the resulting energy to the tempering medium to increase the efficiency of the inverter wave generator.

Bases with a pH value of up to 14 have a corrosive effect and react with metal. This leads to corrosion of pipes carrying the temperature control medium and to silting in the temperature control circuit. To counteract this, it is advantageous to work with a pH value <7.1.

The Cell

The inverter wave generator comprises a cell for temperature control of the tempering medium, which is advantageously movable via means for generating a static pressure, such as pressure maintaining means, and/or via means for generating a dynamic pressure difference, such as an electrically, hydraulically or pneumatically operated pump, and/or via an arrangement for supporting convection by temperature differences in such a way that the tempering medium enters the cell under pressure, is excited there with a stimulating electrical control signal us(t) according to the invention, is moved on into a circuit for recombination after exiting the cell, and is subsequently supplied to the cell again for renewed excitation of the tempering medium. Advantageously, the tempering medium thereby passes through the inlet of a heat exchanger, exchanging its thermal energy with a secondary circuit by raising (heating) or lowering (cooling) the temperature level of the secondary circuit. The secondary circuit can be a gas, such as room air flowing past the heat exchanger, a liquid fluid or a gaseous fluid, which is used in pipes inside a building or a plant for heating and/or cooling.

Preferably, the means for generating a static pressure and/or a dynamic pressure difference can be designed to be intermittently controllable in order to control a phase of higher static pressure or a higher pressure difference with a phase of lower static pressure or a lower pressure difference in time succession according to a defined sequence.

The cell can comprise two electrodes between which the tempering medium can be excited as it passes through the cell by an electric field which can be generated by the stimulating electric control signal us(t) connected to the electrodes. The electrodes comprise electrically conductive material. In advantageous embodiments, the tempering medium is in direct, i.e. electrically conductive, galvanic contact with the electrodes of the cell. Advantageously, in these embodiments, at least the surface of the electrodes comprises electrically conductive material with high corrosion resistance, such as stainless steel, silver, gold, platinum or the like. Alternatively, the transmission of an electric field can be capacitive via insulated electrodes to the tempering medium. Insulation of the electrodes from the tempering medium can advantageously comprise acid- or alkali-resistant electrically non-conductive material such as plastic, rubber, glass or ceramic or the like. Alternatively, electrodes and/or electrode coatings comprising partially electrically conductive material with defined specific electrical resistance, such as ceramic composites or carbon composites or metal foam, are also possible. Optionally, for example, an at least partial coating or at least partial incorporation of gel-containing material is possible, enabling partial galvanically conductive and partial capacitive transmission of the electrical field from the electrodes to the tempering medium. The area of the electrodes effective for the electric field and facing each other between the electrodes, hereinafter also referred to as the electrode area, and/or their average distance is optionally designed to be advantageously variable. The electrode area effective for the electric field and/or their average distance is advantageously controlled in a control unit of the inverter wave generator by a controller as a function of a control deviation.

The electrodes are connected to the poles of an electrical signal source, which delivers the stimulating electrical control signal us(t) to the electrodes of the cell.

In the cell of the inverter wave generator, the oscillation of the molecules or clusters of the tempering medium can be changed by means of a frequency or different frequencies of the stimulating electrical control signal us(t). This is done by changing the movement of the molecules, which alters the friction that arises during their relative movement with respect to one another, thereby generating more heat (heating) or less heat (cooling).

The primary objective is to raise the heat in a tempering medium from a lower temperature level to a higher temperature level. Thus, the system can be used as a primary heat source. Since a higher energy yield is achieved compared to the supplied energy (efficiency >1.0 or >100%), this type of heating is efficient.

An optional aim is to bring about a reduction in the thermal movement of the molecules by shifting the composition of the amplitude spectrum of the frequency components of the stimulating control signal and thus to carry out a reduction in heat, i.e. cooling.

The temperature change can take place in the tempering medium with the generation and the application of at least one defined amplitude and frequency of the stimulating electrical control signal us(t) applied to the electrodes of the cell of the inverter wave generator. Thereby, the stimulating electrical control signal us(t) applied to the electrodes of the cell of the inverter wave generator comprises a defined unipolarity without an alternation of polarity or a defined bipolarity with an alternation of polarity and/or optionally at least partially a defined bipolarity with an at least partial alternation of polarity.

For this reason, the device according to the invention comprises polarity-neutral electrodes which can optionally be driven with at least partially changing electrical polarity of the stimulating control signal, instead of the defined polarity with an exclusively positively driven “anode” with respect to a “cathode” as disclosed in the prior art.

The coating of the tempering medium for guiding in the primary circuit within pipes, pump and the cell comprises either an electrically conductive material such as steel, in particular stainless steel, brass, bronze, copper, aluminum or an alloy with at least these components, carbon-containing material, for example carbon fiber-reinforced plastic and/or electrically non-conductive material such as plastic, silicone, rubber, glass, ceramic, fiber-reinforced plastic, for example glass fiber-reinforced or electrically insulated carbon fiber-reinforced plastic.

The Signal Source

The stimulating electrical control signal us(t) is generated by an analog signal source and/or a digital signal source.

In a first embodiment of the signal source, the generation of several frequency-spectral components of the stimulating electrical control signal us(t) is carried out by the generation of non-sinusoidal periodic voltage waveforms with, for example, a periodic pulse-shaped, rectangular, sawtooth-shaped, triangular waveform or with other periodic waveforms.

Optionally, the subsequent filtering out of the suitable frequency components with defined amplitude and frequency of the periodic stimulating electrical control signal us(t) applied to the electrodes of the cell of the inverter wave generator is carried out by analysis by at least one optional filter. Thereby, the stimulating electrical control signal us(t) applied to the electrodes of the cell of the inverter wave generator optionally comprises a defined unipolarity with no alternation of polarity or optionally a defined bipolarity with an alternation of polarity or optionally at least partially a bipolarity comprising a DC component and at least a partial alternation of polarity.

According to the invention, the repetition frequency of the periodic stimulating electrical control signal us(t) is between 0.1 Hz and 10 kHz. The pulse width of the periodic electrical control signal is in the range between 0.2 μs and 8 s. The amplitude frequency spectrum of the periodic stimulating electrical control signal us(t) has spectral components in the range from 0.1 Hz to 10 MHz and optionally a DC component. The minimum rise time of the periodic stimulating electrical control signal us(t) is more than 0.01 μs, preferably more than 0.1 μs, and the minimum fall time of the periodic stimulating electrical control signal us(t) is more than 0.01 μs, preferably more than 0.1 μs.

Alternatively or additionally, in a second embodiment of the signal source, the generation of at least one sinusoidal single signal component with defined frequency and amplitude is advantageously performed by synthesis in individual signal generators. Several such sinusoidal individual signal components with defined frequency and amplitude and phase position can advantageously be mixed in a mixer of the device, the result of the mixing process being a stimulating electrical control signal which has defined frequencies, amplitudes and phase positions of the spectral components relative to one another.

Thereby, the stimulating electrical control signal us(t) applied to the electrodes of the cell of the inverter wave generator can optionally have a defined unipolarity without an alternation of polarity or optionally a defined bipolarity with an alternation of polarity or optionally at least a partial bipolarity, wherein the control signal comprises a DC component and at least a partial alternation of polarity.

Preferably, the repetition frequency of the periodic stimulating electrical control signal resulting after the mixing process is between 0.1 Hz and 10 kHz according to the invention. The pulse width of the periodic stimulating electrical control signal us(t) is preferably in the range between 0.2 μs and 8 s. The amplitude frequency spectrum of the periodic stimulating electrical control signal us(t) preferably has spectral components in the range of 0.1 Hz to 10 MHz and optionally a DC component. The minimum rise time of the periodic stimulating electrical control signal us(t) is more than 0.01 μs, preferably more than 0.1 μs, and the minimum fall time of the periodic stimulating electrical control signal us(t) is more than 0.01 μs, preferably more than 0.1 μs. Other differentiated repetition frequency patterns, resulting pulse widths, rise and fall times and spectral components are also possible with this generation of the stimulating electrical control signal us(t).

An alternation of polarity of the stimulating electrical control signal us(t) or an at least partially alternating polarity of the electrical control signal us(t) can advantageously increase the efficiency, because the dipoles of the tempering medium are reversed in their geometrical alignment instead of being alternately more or less aligned in one direction only. Furthermore, an alternation of polarity of the electrical control signal us(t) or an at least partial alternation of polarity of the electrical control signal us(t) can optionally reduce or prevent gas formation of the tempering medium at the electrodes.

Advantageously, the stimulating control signal can be conditioned in an amplifier and optionally via a transformer with a rectifier or without a rectifier with regard to electrical voltage amplitude and available signal power or the source impedance before it is applied as a stimulating electrical control signal us(t) to the electrodes of the cell of the inverter wave generator. Optionally, a DC component (offset) can be added in the amplifier to shift the signal by a defined DC value.

The advantageous peak-to-peak value of the electrical voltage amplitude of the stimulating electrical control signal us(t) depends on the respective electrode distance, the electrode area and the respective conductivity of the tempering medium.

The peak-to-peak value of the electrical voltage amplitude can advantageously be in the range of

1 V to 60 V (safety extra-low voltage), or from

60 V to 1000 V, preferably 80 V to 250 V or from

1000 V to 100 kV.

Advantageous examples of a combination of ranges of the electrode distance, the electrode area, the conductivity and the peak-to-peak value of the electrical voltage amplitude are dependent on a defined dispensable power of the signal source, whereby the electrode distance directly proportionally influences the range of the conductivity and the peak-to-peak value of the electrical voltage amplitude and the electrode area inversely proportionally influence the range of the conductivity.

The skilled person recognizes that, depending on the application of the inverter wave generator in a plant or in a building, different dispensable power of the signal source and/or different setting ranges of the electrode distance and/or the electrode area can be used, resulting in different combinations of ranges of the conductivity and the peak-to-peak value of the electrical voltage amplitude.

Furthermore, the skilled person recognizes that, depending on the application of the inverter wave generator in a plant or in a building, several cells and wave generators can be arranged in series or cascaded in parallel in the primary circuit in order to increase the power that can be supplied to the secondary circuit of the plant or the building. Likewise, optionally several primary circuits of, optionally also locally distributed several inverter wave generators can act via several heat exchangers on a common secondary circuit, in order to increase the performance of the temperature control of a plant or the temperature control in a building.

The efficiency of the inverter wave generator is determined by the ratio of the thermal heat energy extracted to the supplied electrical control energy of the stimulating electrical control signal us(t) required for this purpose, taking into account all frequency components contained therein and, if applicable, the DC component.

The efficiency achieved with the device according to the invention is more than 100%, i.e. it is greater than 100 percent.

The Closed-Loop Control

The exact adjustment of the amplitude and the frequency band of the stimulating electrical control signal us(t), which is generated by the signal source, is defined by manual adjustment and/or optionally by means of an analog control unit and/or a digital control unit, and in the case of a digital embodiment with an associated software. The output signal of a function signal generator within the signal source advantageously forms the input signal of the amplifier, which conditions the stimulating electrical control signal with respect to electrical voltage amplitude and available signal power or source impedance, and optionally with admixture of a DC component (offsets). The output signal of the amplifier is either applied directly to the electrodes of the cell of the inverter wave generator or translated via the transformer in the voltage value according to the transformation ratio of the transformer windings as stimulating electrical control voltage us(t) to the electrodes of the cell of the inverter wave generator.

Preferably, the optional rectifier and/or an optional DC voltage source for generating a defined offset can be arranged on the secondary side of the transformer.

Tracking the amplitudes within the frequency band of the electrical control voltage of the stimulating control signal us(t) and/or the parameters of a controlled system can be a prerequisite for the effective functioning of the system. By means of actual value recording in the primary circuit, the current temperature of the tempering medium in the primary circuit, the electrical energy supplied to the cell in a defined measuring period, the thermal energy delivered in the defined measuring period and from this the current efficiency, as well as the conductivity and/or the pH value can be determined. In this process, the optimum values for the temperature and/or the optimum values for the efficiency are digitally recalculated and/or analogously readjusted by control technology and adapted to the current conditions. In this way, a continuous control process is formed in the temperature control medium circuit. The software is optionally and advantageously programmed in such a way that the controller optimizes itself in a self-learning manner. The process is carried out in combination with frequency generation, amplitude control and/or phase control and/or filtering and/or electrode distance and/or electrode area and/or throughput and/or pH value and/or conductivity and/or static pressure of the tempering medium and/or dynamic pressure of the tempering medium and/or control of nozzles of a nozzle plate. Thus, according to the current temperature of the tempering medium and/or the current efficiency, the parameter settings of the controlled system can be adjusted and the result can be used as electrical control voltage of the stimulating electrical control signal us(t) and/or as specifications for the electrode distance and/or as specifications for the electrode area and/or as specifications for the flow rate and/or as specifications for the pH-value and/or as a specification for the conductivity and/or as a specification for the static pressure of the tempering medium and/or as a specification for the dynamic pressure of the tempering medium and/or as a specification for the area of the nozzles of the nozzle plate and/or as a specification for the outlet angle of the nozzles of the nozzle plate are supplied to the cell and the primary circuit.

The processor-controlled digital signal source and/or the controllable analog signal source generates the stimulating electrical control signal us(t) in a controlled manner, preferably by means of a digital closed-loop control by software in the digital control unit and/or analog by means of a control method in the analog control unit optionally on the basis of self-adaptive software.

Advantageously, in one embodiment, the stimulating electrical control signal us(t) can be generated by the digital signal source using a digital signal processor on which the digital closed-loop control, controlled by a computer program, also runs, which can be stored in a memory unit in the inverter wave generator. Alternatively or additionally, in a further embodiment, the generation and closed-loop control can also be performed by analog means.

In operation, the control unit can use one or more temperature sensors to monitor the current temperature of the tempering medium, and the electrical energy consumed and the thermal energy delivered can be determined. The current efficiency can be determined from the quotient. A defined efficiency, also referred to as COP (Coefficient of Performance), and/or a defined temperature can be aimed for as a setpoint.

The efficiency Eta of the device can be determined by the ratio of the thermal energy Eab taken from the primary circuit to the electrical control energy Ezu of the stimulating electrical control signal us(t) supplied to the cell, taking into account all frequency components:

Eta=Eab/Ezu

The energy dissipated can be determined from the temperature change DeltaTeta [Kelvin] achieved at a defined mass mM [gram] of the tempering medium and, in the case of water, from the specific heat capacity according to the following relationship:

Eab=mM*DeltaTeta*4.19 [Ws]

The specific heat capacity can vary according to pressure and temperature. If another dipolar fluid is used as the tempering medium, its specific heat capacity must be taken into account.

Optionally, in addition to the specific heat capacity of the tempering medium, the efficiency is determined by taking into account thermodynamic characteristics of other heat capacities of the components in the primary circuit, for example the tubes, the tube assembly, one or more pumps, the sensors, the pressure compensation vessel, the gas volume of an interior in a closed system, the housing in a closed system, and optionally the heat exchanger and optionally the heat capacities of the components in the secondary circuit.

Furthermore, the efficiency is optionally determined with additional inclusion of thermodynamic characteristics of the heat transfer resistances of components in the primary circuit, for example, the pipes, the pipe assembly, one or more pumps, the sensors, the pressure compensation vessel, the gas volume of an interior space in the case of a closed system, the housing in the case of a closed system, and optionally the heat exchanger and optionally the components of the secondary circuit to a space surrounding the system.

The supplied electrical energy can be determined with a power measuring device with a bandwidth of 0 Hz (DC) up to 10 MHz (AC) to include all harmonic components from the measured supplied active control power Pzu [W] and the defined measuring period t [seconds] in which the delivered thermal energy Eab was generated under supply of electrical energy Ezu. The detection of the supplied electrical energy Ezu can therefore be performed approximately according to the correlation, taking into account the DC component, the fundamental wave and all harmonic components of the supplied active control power Pzu [W] to be measured:

Ezu=Pzu*t [Ws]

In the case of changing values of the supplied electrical power Pzuist within a measuring period t, which follow a time-varying curve progression pzuist(t), for example, a more precise integration of a curve progression pzuist(t)*dt [Ws] can be carried out over the period of the measuring period t instead of a simple area formation for Ezuist by a multiplication Pzuist*t [Ws] in order to determine the supplied electrical energy Ezuist.

In operation, the control unit can monitor the current temperature of the tempering medium in the primary circuit with a temperature sensor or with several temperature sensors and/or determine the energy supplied to the tempering medium with a probe for heat counting. A predetermined temperature and/or a predetermined efficiency can be aimed for. The temperature Tetaist and/or the efficiency Etaist determined continuously in this way can represent the actual values for the controller.

Advantageously, the temperature of the tempering medium in the primary circuit is optionally recorded at several points in the primary circuit. The individual temperatures are processed by calculation and forwarded to the controller for further evaluation of the temperature Tetaist in the primary circuit either as a temperature value or as a temperature difference.

Advantageously, in one embodiment, the temperature is measured at the inlet of the cell and at the outlet of the cell. From the two temperature values, for example, the positive or negative temperature difference caused by the cell can be used as a criterion for the actual value Tetaist for the controller.

Alternatively, a weighted value, for example the average of the two temperature values before the cell and after the cell, can be used as the criterion Tetaist for the actual value for the controller.

Alternatively, several temperature values in the primary circuit can be optionally weighted as the criterion for the actual value Tetaist for the controller.

The targeted defined temperature Tetasoll of the heating/cooling in the primary circuit of the tempering medium and/or optionally a specific time profile for a change in the value for the temperature Tetasoll and/or the targeted defined efficiency Etasoll and/or optionally a specific time profile for a change in the value for the efficiency Etasoll can provide the setpoint settings for the controller. Both variables are advantageously processed, for example, by a decentralized closed-loop control for multivariable systems. Alternatively, other control concepts are possible.

The difference between the setpoint and the actual value provides the control deviation d1 or d2. This can in each case form the criterion for controlling the controlled system by a controller component r1 and/or controller component r2. The controlled system can change the parameter settings on the basis of the controlling specifications via a parameter control signal p1 of controller component r1 and/or via a parameter control signal p2 of controller component r2.

The control unit with or without a self-adaptive function of the controller component can control the properties of the stimulating electrical control signal us(t) via the conductivity and/or via the pH value, the nature and/or the flow rate and/or the static pressure and/or the dynamic pressure of the tempering medium in the primary circuit and/or the electrode distance and/or the electrode area and/or a nozzle setting of the nozzles of the nozzle plate and make continuous corrections.

In the case of a self-adaptive function of the controller, the cell of the inverter wave generator can be successively and self-learningly controlled with the optimum frequency spectrum and the optimum amplitude mix and/or can make corrections on the basis of the self-adaptive function of the controller with an electrode actuator for adjusting the electrode distance and/or the electrode area and/or with a nozzle plate actuator for adjusting the nozzle area and/or the nozzle exit angle with respect to the nozzle plate.

Closed-Loop Control During Signal Generation by Analysis

In one embodiment of the inverter wave generator, a signal with a defined harmonic spectrum is generated in the signal source, for example a pulse-shaped signal with defined unipolarity and with defined frequency, pulse width, edge steepness and amplitude and/or an at least partially bipolar pulse-shaped signal with defined frequency, pulse width, edge steepness and amplitude, and optionally an analysis by filtering to extract and forward defined frequency and amplitude components with defined phase relationship to one another. The fundamental frequency and the harmonics of the stimulating electrical control signal us(t) at the electrodes of the cell can be in a frequency range from 0 Hz up to 10 MHz. This frequency range surprisingly provides an influenceability of water dipoles or water clusters with high efficiency of more than 100% by the stimulating electrical control signal us(t) for the temperature control of water molecules, because a thermally significant influenceability of water dipoles is known so far only from the range of microwaves of more than 2 GHz and thereby with an efficiency of about 60%. The generation and optional filtering in the at least one optional filter can be analog and/or digital.

In the case of the advantageous digital generation and filtering, the individual signal values are present as discrete-time digital time-dependent quantities, which are calculated by a processor controlled by a computer program stored in the device. The individual digital signal values can each represent a signal with a defined time curve of the signal amplitude and its derivatives. The signal can thus follow a defined function and its derivatives as a function of time, for example rectangle, pulse, triangle, sawtooth or other periodic course.

With the aid of digital filter calculation, the calculation of the filter coefficients and the calculation of the resulting signal form after the filter process is advantageously carried out in the processor of the device depending on the specifications of the filter type and the order of the filter. This waveform contains the frequency spectrum defined by the controller component r1 and/or controller component r2 with respect to the respective frequency, amplitude and phase position.

Optionally, controlled by the controller component r1 and/or controller component r2, an additional DC component can be added permanently or temporarily for a defined duration in order to shift the signal partially into the positive or negative range, for example to compensate for possibly undesired DC components or to add an additional DC component to the stimulating control signal. The result is converted from the digital value to an analog signal in a digital to analog (D/A) converter and fed as a controlling signal to the electrodes of the cell of the inverter wave generator or optionally to the inlet of the analog amplifier, which processes the signal in electrical amplitude and power and thus passes it on either directly or translated via the transformer as a stimulating electrical control signal us(t) to the electrodes of the cell of the inverter wave generator.

In the analog embodiment, the signal can be generated, for example, by the analog or digitally controllable function signal generator. The analog or digital optional filters with or without means for adjusting the filter characteristics can be connected downstream. Advantageously, the analog signal is fed to the inlet of the analog amplifier controllable with respect to gain, which processes the signal in electrical amplitude and power and thus transmits it either directly or translated via the transformer as a stimulating electrical control signal us(t) to the electrodes of the cell of the inverter wave generator.

If a transformer is used, the optional rectifier can be arranged on the secondary side of the transformer and/or a DC component can optionally be added at the inlet of the cell of the inverter wave generator.

Alternative embodiments comprise in the analog or digital embodiment, for example, already during signal generation or thereafter by admixing a DC component or an offset at the amplifier for the electrical control voltage applied to the electrodes of the cell of the inverter wave generator of the stimulating electrical control signal us(t) permanently or defined temporarily unipolar course or permanently or defined temporarily bipolar course or permanently or defined temporarily partially bipolar course.

The parameter setting of the controlled system via the parameter control signals p1 and/or parameter control signals p2 can be performed in the embodiment of signal generation in the signal source by analyzing
by changing the curve function of the signal generated by the function signal generator and/or its repetition frequency and/or its pulse width and/or its rise time and/or its fall time and/or its amplitude,
optionally with a controllable DC component with a defined unipolarity without alternation of polarity or a defined bipolarity with alternation of polarity or a defined at least partial bipolarity with at least partial alternation of polarity of the periodic stimulating electrical control signal us(t) applied to the electrodes of the cell,
optionally on the basis of the parameters of the at least one optional filter for a respective lower cut-off frequency and/or a respective upper cut-off frequency and/or a respective quality of the optional at least one filter, wherein optionally the filter can comprise a plurality of filters cascaded in parallel and/or in series and filters of higher order, and wherein the at least one optional filter is arranged in the signal path between the output of the function signal generator serving as electrical signal source and the electrodes of the cell or within the signal source upstream of a power output stage
optionally, when the amplifier is used, by means of the amplifier setting for the amplitude and optionally by controlling a DC component (offset) of the periodic stimulating electrical control signal us(t) applied to the electrodes of the cell,
optionally by changing the conductivity on the basis of a change in the ion concentration in the tempering medium by adding acidic, basic or neutral fluid via the conductivity dosing pump and exchange device,
optionally by changing the pH value, whereby the defined pH value is readjusted via a dosing pump,
optionally by changing the electrode distance and/or the electrode area, for example, via a manually operated mechanical adjustment device and/or via at least one electric, hydraulic, pneumatic, magnetic or piezoelectric electrode actuator,
optionally by changing the flow rate of the tempering medium in the primary circuit and thus in the cell, for example by changing the pump speed in the primary circuit or by changing the cross section in the primary circuit,
optionally by changing the static pressure of the tempering medium in the primary circuit and thus in the cell, for example by changing the pump speed in the primary circuit or by changing the cross-section in the primary circuit, or by adding or extracting tempering medium by means of dosing pumps,
optionally by intermittent time control of control parameters of frequency generation, amplitude control and/or phase control and/or of the at least one optional filter and/or of the electrode distance and/or of the electrode area and/or of the flow rate and/or of the pH value and/or of the conductivity and/or of the static pressure and/or of the dynamic pressure of the tempering medium and/or of a nozzle area and/or of a nozzle outlet angle of the nozzles of the nozzle plate.

Closed-Loop Control for Signal Generation by Synthesis

In a further embodiment of the inverter wave generator, a synthesis of signals can take place in the signal source, whereby at least one sinus signal generator can generate a sinusoidal signal with a defined frequency and amplitude. Several generated sinusoidal signals, each with a defined frequency and amplitude, can additionally be assigned to one another in the respective phase position of the signals, and the signals can be mixed to form a signal in a mixing stage. Optionally, a DC component can also be added, for example to partially shift an initially purely bipolar signal into the positive or negative range, for example to compensate for any undesirable DC components or to add additional DC components to the stimulating control signal. Generation, signal processing and mixing are performed digitally and/or analogously.

Alternative embodiments can comprise in the analog or digital embodiment, for example, already during signal generation or thereafter by mixing in a DC component or an offset at the amplifier for the electrical control voltage applied to the electrodes of the cell of the inverter wave generator of the stimulating electrical control signal us(t) permanently or defined temporarily unipolar course or permanently or defined temporarily bipolar course or permanently or defined temporarily partially bipolar course.

In the case of advantageous digital generation and processing, the individual discrete-time signal values can be present as digital time-dependent quantities which can be calculated by a processor controlled by a computer program stored in the inverter wave generator. The individual digital signal values can each represent a sinusoidal signal with defined frequency and amplitude. Several generated sinusoidal signals with defined frequency and amplitude can additionally be assigned to each other in the respective phase position of the signals. A mixing of the signals to a common signal can be done in a computational mixing operation. Optionally, a DC component can also be added to shift the signal partially into the positive or negative range, for example to compensate for any undesired DC components or to add additional DC components to the stimulating control signal.

The result can be converted from the digital value into an analog signal in the D/A converter and fed as a controlling signal to the electrodes of the cell of the inverter wave generator or optionally to the inlet of the analog amplifier, which processes the signal in amplitude and power and thus passes it on either directly or translated via the transformer as a stimulating electrical control signal us(t) to the electrodes of the cell of the inverter wave generator. If the transformer is used, the optional rectifier can be arranged on the secondary side of the transformer and/or a DC component can optionally be added at the inlet of the cell of the inverter wave generator.

In the analog embodiment of the signal generation in the signal source by synthesis, the signal can be generated, for example, by at least one analog function sinus signal generator that can be controlled in terms of frequency and/or amplitude and/or phase position and by a controllable analog mixing stage.

Optionally, a controllable DC component can be added to shift an initially purely bipolar signal partially into the positive or negative range, for example to compensate for any undesirable DC components or to add an additional DC component to the stimulating control signal. Advantageously, the analog controlling signal is fed to the inlet of the analog amplifier, which is controllable with respect to gain factor, and which processes the signal in amplitude and power and thus transmits it either directly or translated via the transformer as a stimulating control signal to the electrodes of the cell of the inverter wave generator. If the transformer is used, the optional rectifier can be arranged on the secondary side of the transformer and/or a DC component can optionally be added at the inlet of the cell of the inverter wave generator.

The frequency of the stimulating electrical control signal us(t) at the electrodes of the cell can be from 0 Hz up to 10 MHz. This frequency range provides the surprising effect of influenceability with high efficiency of more than 100% by the stimulating electrical control signal us(t) for temperature control of water molecules, because a thermal influenceability of the water dipoles is known so far only from the range of microwaves of more than 2 GHz with an efficiency around 60%.

Alternative embodiments can comprise in the analog or digital embodiment, for example, already during signal generation or thereafter by admixing a controllable DC component or an offset at the amplifier for the electrical control voltage of the stimulating electrical control signal us(t) applied to the electrodes of the cell of the inverter wave generator permanently or defined temporarily unipolar course or permanently or defined temporarily bipolar course or permanently or defined temporarily partially bipolar course.

The parameter setting of the controlled system via the parameter control signals p1 and/or parameter control signals p2 can take place in the embodiment of signal generation in the signal source by means of synthesis
by means of the generation of at least one sinusoidal signal by at least one single sinusoidal signal generator with a defined frequency and amplitude predetermined by the controller component r1 and/or controller component r2,
in the case of a plurality of such sinusoidal individual signal components, by the defined individual frequencies specified by the controller component r1 and/or controller component r2 to the individual sinusoidal signal generators and by specified individual defined amplitudes and by specified individual defined phase positions of the individual signals relative to one another,
in the case of several signals generated by individual sinus signal generators, by mixing the individual signals in an optionally controllable mixer,
by the electrical control voltage of the stimulating control signal applied to the electrodes of the cell of the inverter wave generator with a defined unipolarity without an alternation of polarity or a defined at least partial bipolarity with an at least partial alternation of polarity,
optionally, when using the amplifier, by means of the amplifier setting for the amplitude of the signal applied to the electrodes of the cell,
optionally by changing the conductivity on the basis of a change in the ion concentration in the tempering medium by addition of acidic, basic, or neutral fluid via the conductivity dosing pump and exchange device,
optionally by changing the pH value, whereby the optimum pH value is readjusted via a dosing pump,
optionally by changing the electrode distance and/or the electrode area, for example via a manually operated mechanical adjustment device and/or at least one electric, hydraulic, pneumatic, magnetic or piezoelectric electrode actuator,
optionally by changing the flow rate of the tempering medium in the primary circuit and thus in the cell, for example by changing the pump speed in the primary circuit or by changing the cross section in the primary circuit,
optionally by changing the static pressure of the tempering medium in the primary circuit and thus in the cell, for example by changing the pump speed in the primary circuit or by changing the cross-section in the primary circuit or by adding or extracting tempering medium by means of a dosing pump,
optionally by intermittent time control of control parameters of frequency generation, amplitude control and/or phase control and/or electrode distance and/or electrode area and/or flow rate and/or pH value and/or conductivity and/or static pressure and/or dynamic pressure of the tempering medium and/or nozzle area and/or nozzle exit angle of the nozzles of the nozzle plate.

The controller is advantageously implemented in the aforementioned at least partial digital embodiments by a processor, in particular a signal processor with a program stored in the device for controlling the process steps according to the invention, taking into account the detected actual values and the specified setpoint values.

Although the control cycles are relatively slow in the range of several seconds to minutes, since the acquisition of the actual value for the partially thermally determined efficiency is relatively sluggish, a clock frequency of over 100 MHz of the processor is advantageous with regard to the cutoff frequency of the harmonics to be processed of the stimulating electrical control signal us(t) at the electrodes of the cell of up to 10 MHz, in order to avoid aliasing effects. The slow control cycles do not pose a problem in the context of a heating/cooling system.

The parameter combinations are set under program control in the defined method steps by successive variation of the parameter settings.

Advantageously, the variation of the parameter settings can be carried out on the basis of randomized procedures such as a so-called Monte Carlo algorithm or a so-called Las Vegas algorithm or the like.

Parameter settings that have been carried out successfully and, if necessary, also unsuccessfully, depending on the process, and their initial situation can advantageously be stored in a memory device of the device and, depending on the initial situation, be selected again later with higher priority and stored again if successful. In this way, the controller “learns” from its previous successfully and, if necessary, also unsuccessfully performed parameter settings and can thus successively optimize itself and the controller for successful parameter settings for generating the stimulating control signal and/or for setting the electrode distance and/or the electrode area and/or the throughput and/or the pH value and/or the conductivity and/or the static pressure and/or the dynamic pressure of the tempering medium and/or the nozzle area and/or the nozzle exit angle of the nozzles of the nozzle plate, depending on the dimensions of the device and depending on its operating conditions.

In addition to conventional controllers, so-called “fuzzy controllers” can also be advantageously used for the implementation, which, in contrast to narrowly tolerated values, enable the use of widely tolerated “fuzzy” value ranges. “Fuzzy controllers” are advantageously suited for the implementation of the technical process with optionally several input and output variables with changing mutually influencing parameters and non-linear subsystems.

The control unit can optimize itself independently via the self-learning function. If the efficiency Etaist and/or the temperature Tetaist deviate from the setpoint values Etasoll or Tetasoll during operation, the parameter settings can be successively varied and readjusted until the deviation successively approaches zero or is eliminated. This is a continuous process that takes place throughout the entire operation.

Preferably, parameter sets already successfully determined for a defined embodiment of the inverter wave generator are optionally stored as start values for commissioning the control unit in the electronic control unit of the inverter wave generator or in a remote computer and can be called up from there by the control unit or, in the case of manual operation, by an operator.

The Electrode Control

To control the efficiency and/or to control the temperature, the distance between the electrodes and/or the electrode area can optionally be adjusted, manually or via electrode actuators, such as by an electric, magnetic or hydraulic actuator or rather drive. The electrode actuators can be controlled by parameter setting via the parameter control signals p1 and/or parameter control signals p2, controlled by the controller component r1 and/or controller component r2.

The Temperature control of the tempering medium may be accomplished by generating one frequency or different frequencies at the electrodes of the cell. The signal source can generate the stimulating electrical control signal us(t), comprising an amplitude with one frequency or the stimulating electrical control signal us(t), comprising amplitude components at several frequencies, which can be superimposed. This means that not only one working frequency is used, but usually the amplitude components of several discrete frequencies or the amplitude spectrum of a partially continuous frequency range are superimposed. These electrical frequency components can be conducted to the electrodes in the inverter wave generator and can generate an electrical field there. In the process, the tempering medium can start to oscillate and can generate a temperature increase due to increasing friction of the water molecules or a temperature decrease due to decreasing friction. In relation to the mass and heat capacity of the tempering medium, the temperature difference corresponds to the thermal energy converted in the process.

The exact matching of the amplitudes of the frequency components of the stimulating electrical control signal us(t) in synergy with the conductivity of the tempering medium as a function of a defined electrode distance and/or the electrode area and optionally with the control of the electrode distance and/or the electrode area, manually or by means of the control unit with associated software, is a prerequisite for the efficiency of the inverter wave generator with an efficiency above 100%.

The conductivity and/or the pH value can be measured via the probes in the temperature control medium circuit. The optimum value can be constantly recalculated and adapted to the current conditions. This enables a continuous control process in the temperature control medium circuit. The software can be programmed in such a way that the electronic control unit, in a self-adaptation, can optimize itself in a self-learning manner. The closed-loop control can be performed in conjunction with the other parameters. According to the current temperature of the tempering medium and/or the current efficiency, the conductance and the pH value in the tempering medium can be adjusted and in synergy with this, the operating frequencies and the amplitudes of the stimulating electrical control signal us(t) as well as optionally the electrode distance and/or the electrode area and/or the static pressure in the tempering medium and/or the dynamic pressure in the tempering medium and/or the nozzle area and/or the nozzle exit angle of the nozzles of the nozzle plate can be adjusted.

Swirling

In the inverter wave generator, in a preferred embodiment, the tempering medium can be swirled in a first step as it exits the cell in the nozzle plate at the exit opening. Subsequently, after the next entry of the tempering medium into the cell, the tempering medium can be made to oscillate via the stimulating electrical control signal us(t) with resonance frequency applied to the electrodes or via a resonance frequency spectrum of the electrical drive voltage generated by the stimulating electrical control signal us(t). By means of a resonance frequency or several resonance frequencies, oscillations can be generated in the tempering medium. This can cause the tempering medium to oscillate and generate heat by increasing the frictional movement of the water molecules, or heat extraction or cooling by reducing the frictional movement of the water molecules. If the molecules of the tempering medium and the inverter are oscillating, an acceleration or deceleration of the molecules in the tempering medium can occur accordingly due to the resonance increases in the inverter wave generator. The resulting or reduced frictional energy can be converted into heat or cooling. After the tempering medium has passed through the electrodes, the tempering medium can optionally be swirled again via the nozzle plate and its natural oscillations can be neutralized in the process.

Optionally, another nozzle plate for swirling can be provided at the inlet opening of the cell, or a nozzle plate can be provided only at the inlet opening of the cell.

Optionally, at least one flow element can be provided in the cell or in the pipe connection piece of the cell at the inlet opening and/or at the outlet opening of the cell in order to support a defined flow of the tempering medium. Further flow elements can advantageously be arranged within the primary circuit.

Cluster Resolution in Inverter Wave Generator

The molecular clusters of the dipolar tempering medium water each oscillate at a characteristic frequency. However, they are able to restructure themselves internally and in this way resonate with waves of electric fields. In this way, the external oscillation is absorbed by the water. If one wants to delete these foreign frequencies in the water, one must dissolve the cluster structures again.

The water can take over the oscillations of the electric fields by restructuring its clusters accordingly. Depending on the external oscillation, the water molecules regroup in such a way that the natural frequency of the clusters resonates with the external oscillation. One could also say that the water internalizes the external oscillations.

The swirling technique represents the most effective method to date of changing the stored information. By changing the oscillation of the natural frequency of the clusters, the temperature of the tempering medium can be raised or lowered depending on the external oscillation of the stimulating control signal applied to the electrodes of the cell, and this can be done by supplying less electrical energy than can be tapped in the form of thermal energy.

A swirling can optionally take place, for example, via the nozzle plate at an inlet opening and/or at an outlet opening of the cell and/or via a coiled and/or funnel-shaped and/or helical guide of the tubes and/or in a swirling chamber of the primary circuit. The nozzle plate comprises at least one nozzle having at least one nozzle bore with a flow channel. The arrangement of nozzle bores of the nozzle plate and a helical orientation of the nozzle bores of the nozzle plate in the direction of flow are advantageously designed in such a way that, when the tempering medium is passed through the primary circuit, swirling occurs in a flow direction of the tempering medium v with the greatest possible swirling. Optimally, a funnel-shaped vortex can form in the direction of flow of the tempering medium v, as observed in nature by Mr. Viktor Schauberger, for example.

In another embodiment, the nozzle plate may comprise adjustable flow elements whose openings and/or angles are adjustable relative to the surface of the nozzle plate. In this context, the openings and/or the outlet angle of the nozzles can be arranged in the nozzle plate in an adjustable and fixable manner, for example via a perforated disc that can be rotated with respect to the nozzle plate and/or an adjustable pipe section, which control the opening and/or the outlet angles of the nozzles that are helical in the flow direction. The adjustment can be performed manually and/or via actuators, for example by the electric, pneumatic, hydraulic or magnetic nozzle plate actuator. The actuators are advantageously controlled by parameter settings via the parameter control signals p1 and/or p2, controlled by the controller component r1 and/or r2, in such a way that controlled swirling can take place, with which, in synergy with the other parameter settings, the set temperature Tetasoll and/or the set efficiency Etasoll can be successively set in the course of the control cycle.

Optionally, the nozzle plate comprises at least one nozzle having at least one flow channel, in which the inlet opening is offset by at least 1 degree relative to the outlet opening and the flow channel passes from the inlet opening in a stepwise or continuous manner to the outlet opening, as a result of which a tempering medium flowing through the nozzle plate undergoes a rotation of at least 1 degree, which rotation can continue in a spiral shape in the primary circuit after leaving the nozzle plate.

The rotation of a flow channel can comprise from 1 degree to several rotations of 360 degrees each. Advantageously, the rotation of one or more flow channels is optionally designed to be adjustable manually or via an actuator.

Advantageously, the nozzle plate comprises several flow channels arranged in parallel, in which the inlet opening is offset by at least 1 degree relative to the outlet opening and the flow channel passes from the inlet opening in a stepped or continuous helical manner to the outlet opening, as a result of which a tempering medium flowing through the nozzle plate undergoes a rotation of at least 1 degree, which can continue in a helical manner in the primary circuit after leaving the nozzle plate.

In another advantageous embodiment, the nozzle plate may comprise adjustable flow elements whose openings and/or angles are adjustable relative to the surface of the nozzle plate. In this context, the openings and/or the outlet angle of the nozzles can be arranged in the nozzle plate in an adjustable and fixable manner, for example via a perforated disc that can be rotated with respect to the nozzle plate and/or an adjustable pipe section, which control the opening and/or the outlet angles of the nozzles that are helical in the flow direction.

The nozzle plate may comprise solid material, for example metal, plastic, or glass.

Advantageously, the material of the nozzle plate may alternatively or additionally comprise elastic material, such as permanently elastic plastic, rubber, silicone, or a metallic spring or a spring made of plastic, whereby the openings of the flow channels and/or the angle of one or more flow channels relative to the surface of the nozzle plate can be adjusted by deforming the material of the nozzle plate.

The adjustment can be performed manually and/or via actuators, for example by the electric, pneumatic, hydraulic or magnetic nozzle plate actuator. The actuators are advantageously controlled by parameter settings via the parameter control signals p1 and/or p2, controlled by the controller component r1 and/or r2, in such a way that controlled swirling can take place, with which, in synergy with the other parameter settings, the set temperature Tetasoll and/or the set efficiency Etasoll can be successively set in the course of the control cycle.

Optionally, the nozzle plate in the embodiments mentioned with at least one flow channel or with several flow channels closes off the space between the electrodes in such a way that the tempering medium is guided primarily between the electrodes when circulating in the primary circuit.

By swirling the tempering medium between the electrodes of the cell, the effect of the stimulating electrical control signal us(t) on the molecules of the tempering medium is increased because the total number of molecules or molecule clusters flowing past the electrodes and the number of molecules or molecule clusters not yet stimulated and yet to be stimulated flowing past the electrodes is increased. Furthermore, the recombination of stimulated molecules or molecule clusters of the tempering medium in the primary circuit is further supported.

The principle of swirling in the primary circuit optionally implemented in the embodiments, in particular at the inlet opening and/or at the outlet opening, can make an advantageous contribution to an efficient embodiment of the invention.

The operation of an inverter wave generator for temperature control of a tempering medium is basically carried out in the following method steps in the embodiments described:
providing an inverter wave generator with the described features, wherein
a tempering medium is moved in a primary circuit,
the tempering medium being supplied in the primary circuit to a cell comprising a first electrode and a second electrode
a stimulating electrical control signal us(t) is applied to the electrodes in direct electrical contact with the tempering medium, whereby
the tempering medium in the cell between the electrodes is subjected to an electric field which influences the orientation of the particles of the tempering medium according to their polarity and thereby changes the temperature Tetaist of the tempering medium in the primary circuit,
the tempering medium in the primary circuit is fed to the inlet of a heat exchanger and at least partially releases thermal energy in the heat exchanger to the outlet of the heat exchanger.

Alternatively, the method of transferring the electric field from the electrodes to the tempering medium can be done capacitively, without galvanic contact between the electrodes and the tempering medium.

The reproducible efficiency of the inverter wave generator device according to the invention can be over 100% using the defined parameter settings or with the method according to the invention and the parameter settings made with it. A comprehensive theory of the thereby in the tempering medium observable and/or further, possibly still unknown thereby proceeding phenomena in the tempering medium is however not necessary for the successful operation of the inverter wave generator.

### BRIEF DESCRIPTION OF THE DRAWINGS

These and other features of the present invention will be apparent from the following description of preferred embodiments of the present invention, which are non-limiting examples, with reference to the following figures.

FIG. 1 shows a preferred embodiment of a cell of an inverter wave generator in longitudinal section,

FIG. 2 shows the block diagram of a preferred embodiment of a signal source and the arrangement of the cell in the primary circuit,

FIG. 3 shows the block diagram of a preferred embodiment of the signal source with a transformer and the arrangement of the cell in the primary circuit,

FIG. 4 shows a preferred embodiment of the structure of an optional nozzle plate for swirling a tempering medium,

FIG. 5 shows another preferred embodiment for the structure of the optional nozzle plate for swirling the tempering medium,

FIG. 6a shows an example of the course of bipolar amplitude components of different frequency of a signal with alternating polarity in the time domain,

FIG. 6b shows the frequency spectrum of a bipolar signal with amplitude components of different frequency with changing polarity in the frequency domain,

FIG. 7a shows an example of the course of unipolar amplitude components of different frequency of a signal with constant polarity in the time domain,

FIG. 7b shows the frequency spectrum of a unipolar signal with amplitude components of different frequency with constant polarity in the frequency domain,

FIG. 8 shows the block diagram of the decentralized multivariable control unit implemented as an example,

FIG. 9 shows a preferred embodiment of a controlled system with analytical signal generation,

FIG. 10 shows a preferred embodiment for a controlled system with synthetic signal generation,

FIG. 11a shows the perspective view of a nozzle plate as seen from below,

FIG. 11b shows the perspective view of a nozzle plate as seen from above,

FIG. 12a shows the view from below, a section AA from the side and the front view of a nozzle plate, and

FIG. 12b shows the top view of a nozzle plate.

Common reference signs are used throughout the figures to indicate similar features.

### DETAILED DESCRIPTION

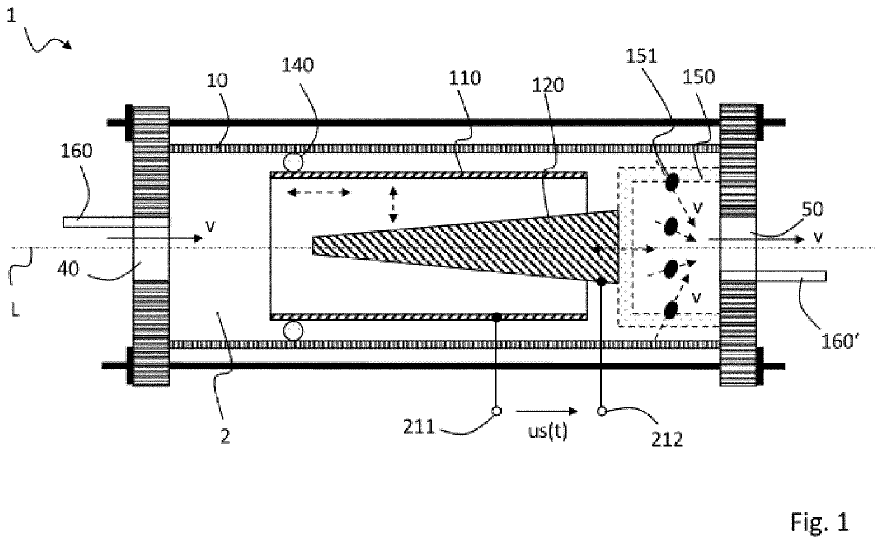

The preferred embodiment shown in FIG. 1 exemplifies a longitudinal section through a cell 1 of the inverter wave generator for temperature control of a tempering medium 2.

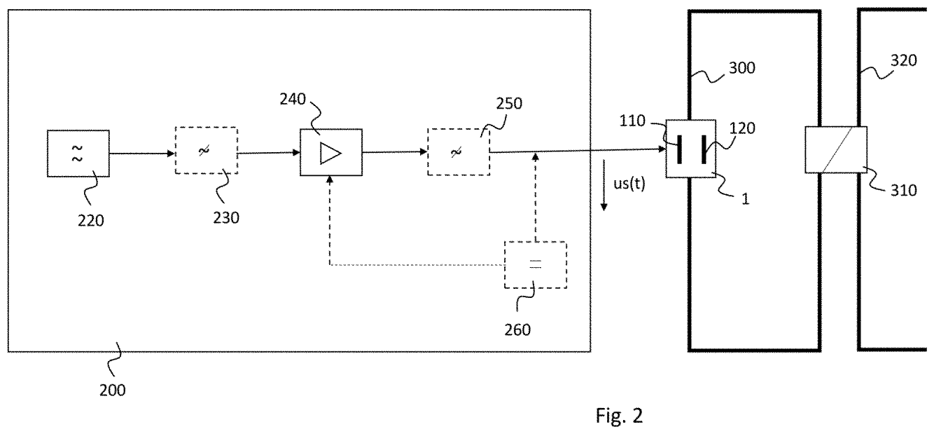

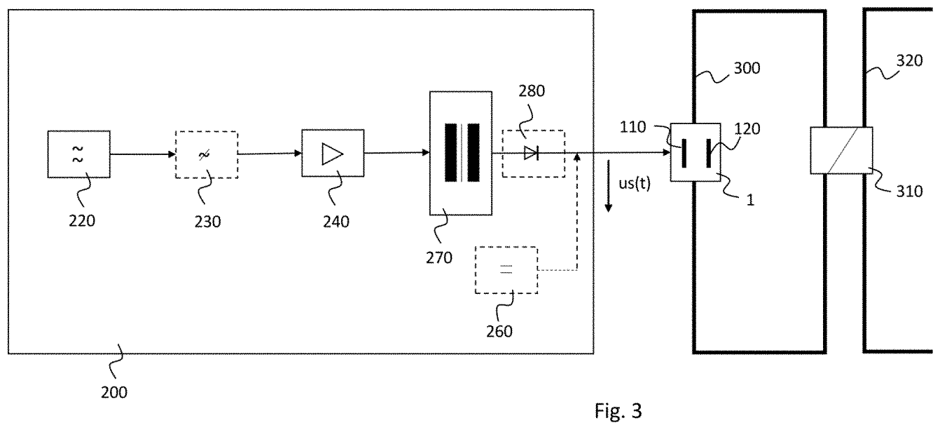

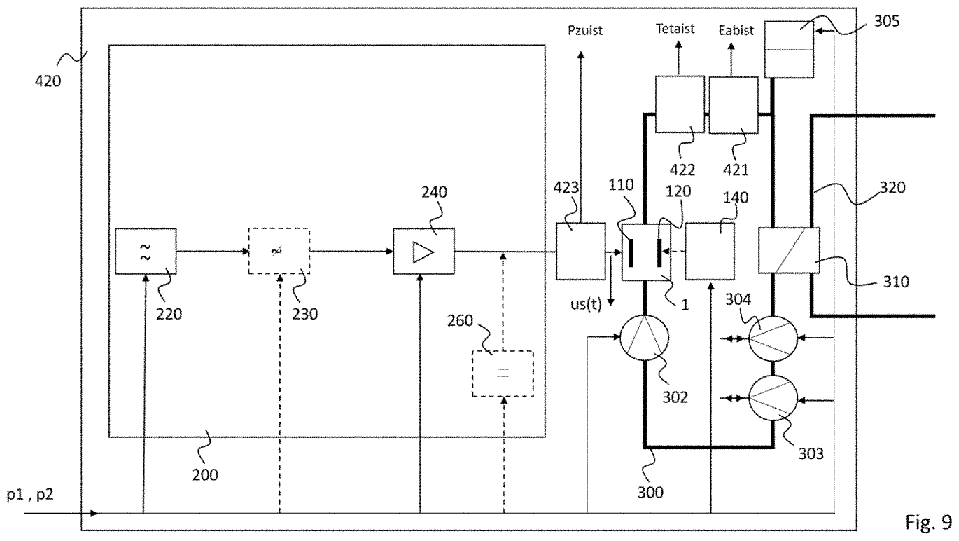

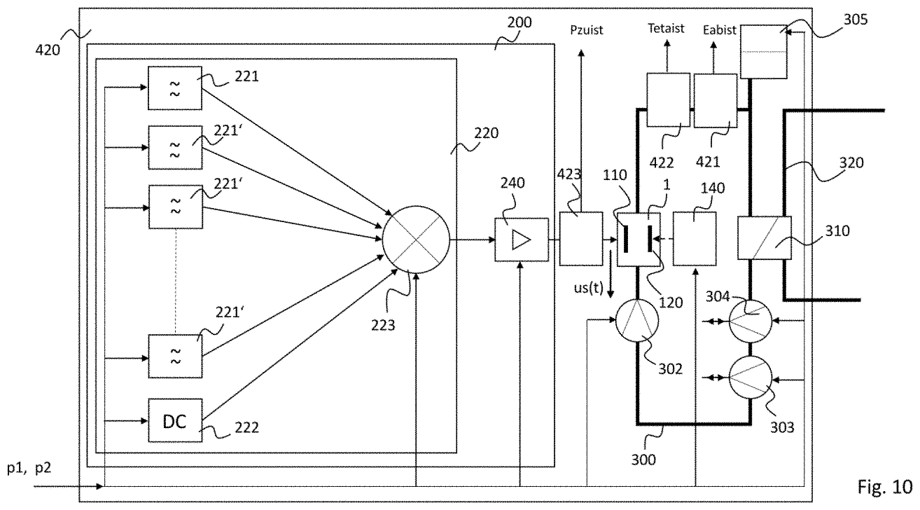

The tempering medium 2 is advantageously movable via means for generating a static pressure 303, 304, 305 (shown in FIG. 9 and FIG. 10) and/or means for generating a dynamic pressure difference 302 such as an electrically, hydraulically or pneumatically operated pump (shown in FIG. 9 and FIG. 10) and/or an arrangement for supporting convection by temperature differences. In this case, the tempering medium 2 enters the cell 1 via an inlet opening 40, through which it passes substantially along a longitudinal axis L of the cell 1. The tempering medium 2 is excited in the cell 1 with the stimulating electrical control signal us(t) according to the invention, is moved on after exiting the cell 1 via an outlet opening 50 into a primary circuit 300 (shown in FIG. 2, FIG. 3, FIG. 9 and FIG. 10) with recombination of the tempering medium 2, and is then fed back to the cell 1 via the inlet opening 40 for renewed excitation. Advantageously, the tempering medium 2 thereby passes through the inlet of a heat exchanger 310 (shown in FIG. 2, FIG. 3, FIG. 9 and FIG. 10), exchanging its thermal energy in the heat exchanger 310 and making it available to a secondary circuit 320 at the outlet of the heat exchanger 310 by raising (heating) or lowering (cooling) the temperature level of the secondary circuit 320.

The cell 1 comprises a first electrode 110 and a second electrode 120, between which the tempering medium 2 can be excited by an electric field as it passes through the cell 1.

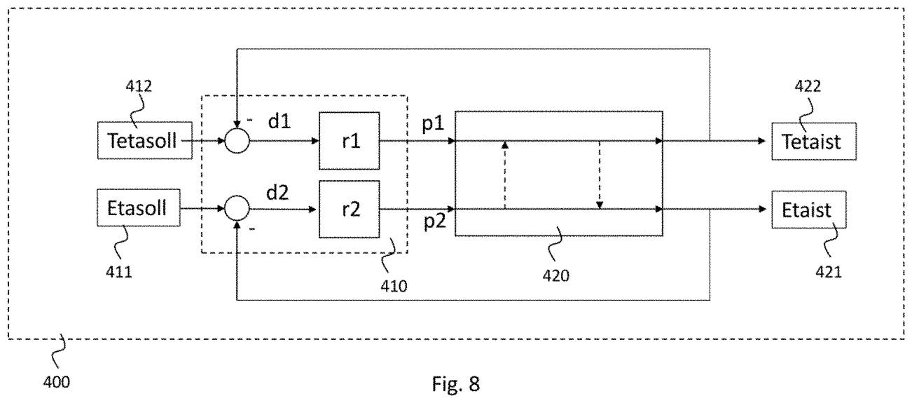

The electrode area between the electrodes 110, 120 that is effective for the electric field and/or their distance is optionally embodied in an advantageous manner, for example, via an electrode actuator 140. The effective electrode area for the electric field between the electrodes 110, 120 and/or their distance is advantageously controlled by a control unit 400 (shown in FIG. 8, FIG. 9 and FIG. 10) of the inverter wave generator as a function of a control deviation.

To control the efficiency and/or the temperature, the distance between the electrodes 110, 120 can optionally be adjusted manually and/or via at least one electrode actuator 140, such as by an electric, magnetic or hydraulic actuator. The electrode actuators 140 are controlled in a controlled system 420 (shown in FIG. 9 and FIG. 10) of the control unit 400 (shown in FIG. 8) via a parameter control signal p1 and/or a parameter control signal p2, controlled by a controller component r1 and/or a controller component r2 of a controller 410 of the control unit 400.

The dipolar tempering medium 2 used in the inverter wave generator is based on hydrogen bonds. The tempering medium 2 comprises, for example, water, in particular advantageously specially prepared neutral water, which can optionally be enriched with additives. In principle, other fluids with dipolar hydrogen bonding are also possible as tempering medium 2.

The conductivity of the water used as tempering medium 2 preferably has values in the range from 0.055 μS/cm to 200 S/m.

In synergy with further parameters according to the invention, which are controlled via a parameter control signal p1 and/or a parameter control signal p2, the invention has the following ranges of values for the electrical conductivity of the tempering medium 2 in two substantially alternative groups of embodiments I and II:

I. Largely Gas-Free Temperature Control

For largely gas-free temperature control of the tempering medium 2, a low to medium conductivity of 0.055 μS/cm to 500 μS/cm, in particular 0.1 μS/cm to 100 μS/cm, preferably 10 μS/cm to 50 μS/cm, of the tempering medium 2 is used, whereby values of 20 μS/cm to 30 μS/cm have proved to be particularly advantageous in synergy with further parameters according to the invention, which are controlled via the parameter control signals p1 and/or p2.

II. Temperature Control of the Tempering Medium Under More or Less Strong Gas Formation

For temperature control of the tempering medium 2 with more or less strong gas formation of the tempering medium 2, a medium to high conductivity of 0.05 S/m to 200 S/m, in particular from 0.05 S/m to 5 S/m and preferably from 0.05 S/m to 0.5 S/m of the tempering medium 2.

In both cases, the electrodes 110, 120 are connected to poles 211, 212 of an electrical signal source 200 which delivers the stimulating electrical control signal us(t) to the electrodes 110, 120 of the cell 1.

In the cell 1 of the inverter wave generator, the oscillation of the molecules or clusters of the tempering medium 2 can be changed by means of a frequency or different frequencies of the stimulating electrical control signal us(t). By changing the molecular motion, the friction generated during the relative motion is changed and thus more heat (heating) or less heat (cooling) is generated.

The primary aim is to raise the heat in a tempering medium 2 from a lower temperature level to a higher temperature level. Thus, the inverter wave generator system can be used as the primary heat source. Since a higher energy yield is achieved compared to the supplied energy (efficiency >1.0 or >100%), this type of heating is efficient.

The optional aim is to reduce the thermal movement of the molecules by shifting the composition of the amplitude spectrum of the frequency components of the stimulating control signal us(t) and thus to reduce the heat, i.e. to cool the molecules.

The temperature change can take place in the tempering medium 2 with the generation and application of at least one defined amplitude and frequency of the stimulating electrical control signal us(t) applied to the electrodes 110, 120 of cell 1 of the inverter wave generator.

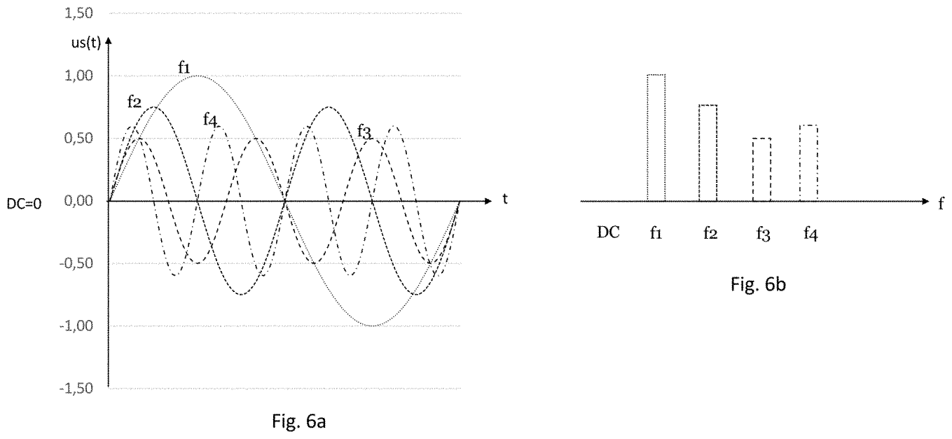

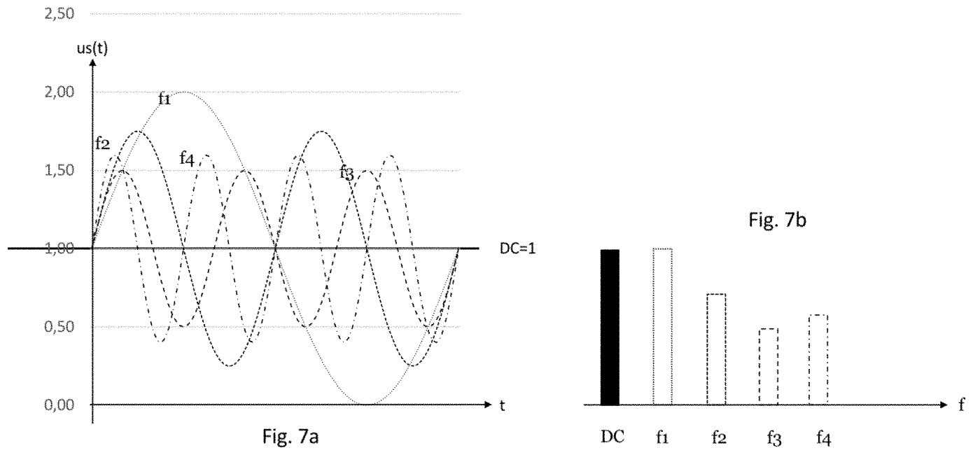

Thereby, the stimulating electrical control signal us(t) applied to the electrodes 110, 120 of the cell 1 of the inverter wave generator comprises a defined unipolarity without alternation of polarity (for example shown in FIG. 7a) or a defined bipolarity with alternation of polarity (for example shown in FIG. 6a) or at least partial bipolarity with an at least partial alternation of polarity.

For this reason, the cell 1 according to the invention comprises polarity-neutral electrodes 110, 120, which are optionally driven with at least partially changing electrical polarity of the stimulating electrical control signal us(t), instead of an anode driven with respect to a unipolar aligned cathode with exclusively unipolar changing voltage values and unipolar aligned as in the prior art.

The advantageous peak-to-peak value of the electrical voltage amplitude of the stimulating electrical control signal us(t) depends on the respective electrode distance of the electrodes 110, 120, the electrode area of the electrodes 110, 120, and on the respective conductivity of the tempering medium 2.

The peak-to-peak value of the electrical voltage amplitude of the stimulating electrical control signal us(t) is advantageously in the range of

1 V to 60 V (safety extra-low voltage), or from

60 V to 1000 V, preferably 80 V to 250 V or from

1000 V to 100 kV.

Advantageous examples of synergy of a combination of ranges of the electrode distance of the electrodes 110, 120, the electrode area of the electrodes 110, 120, the conductivity of the tempering medium 2 and the peak-to-peak value of the electrical voltage amplitude of the stimulating electrical control signal us(t) are shown in the following table.

The table shows values for a defined mappable power of the signal source 200, where the electrode distance of the electrodes 110, 120, directly proportionally influences the range of conductivity of the tempering medium 2 and the peak-to-peak value of the electrical voltage amplitude of the stimulating electrical control signal us(t) and the electrode area of the electrodes 110, 120, inversely proportionally influence the range of conductivity.

| Elektrode | Elektrode | | Peak-to-peak value |
|---|---|---|---|
| distance | area | Conductivity | of the electrical |
| [mm] | [cm²] | [S/m or μS/cm] | voltage amplitude [V] |
| 1-5 | 25 to | 0.18 μs/cm to | 1 V to |
| | 150 | 200 S/m | 60 V |
| 1-5 | 1 to | 0.1 μS/cm to | 60 V to |
| | 100 | 1.4 S/m | 1000 V |
| 5-60 | 1 | 0.06 μS/cm to | 1000 V to |
| | | 0.005 S/m | 100 kV |
| 5-20 | 100 | 130 μS/cm to | 1 V to |
| | | 200 S/m | 60 V |
| 5-20 | 1 to | 0.5 μS/cm to | 60 V to |
| | 100 | 6 S/m | 1000 V |
| 60-100 | 1 | 0.06 μS/cm to | 1000 V to |
| | | 0.1 S/m | 100 kV |
| 2-20 | 10 to | 550 μS/cm to | 1 V to |
| | 100 | 200 S/m | 60 V |
| 20-100 | 0.15 to | 2 μS/cm to | 60 V to |
| | 100 | 186 S/m | 1000 V |
| 20-100 | 0.1 to | 0.07 μS/cm to | 1000 V to |
| | 0.3 | 1 S/m | 100 kV |

The skilled person recognizes that, depending on the application of the inverter wave generator in a plant or in a building, a different output power of the signal source 200 and/or other setting ranges of the electrode distance and/or the electrode area can also be used, which can result in other combinations of ranges of the conductivity and the peak-to-peak value of the electrical voltage amplitude than those shown in the table examples.

Further, the skilled person recognizes that, depending on the application of the inverter wave generator in a plant or in a building, a plurality of cells and/or wave generators may be arranged in series or cascaded in parallel in the primary circuit 300 so as to increase the power that can be dissipated via the heat exchanger 310 to the secondary circuit 320 of the plant or building. Similarly, multiple primary circuits 300 of locally distributed multiple inverter wave generators can optionally act on a common secondary circuit 320 via multiple heat exchangers 310, thereby increasing the power of a plant or in a building and optionally spatially distributing temperature control.

In the embodiment of the cell 1 of FIG. 1, a nozzle plate 150 with nozzles 151 for swirling the tempering medium 2 is attached to the outlet opening 50 of the cell 1. The attachment of one or more nozzle plates generally increases the effectiveness of the device, but is optional.

In this embodiment, the tempering medium 2 is swirled helically in the flow direction of the tempering medium v in a first step before exiting the cell 1 through the outlet opening 50 in the nozzle plate 150. Subsequently, after the next entry via the inlet opening 40 into the cell 1, the tempering medium 2 is set into oscillation via the stimulating electrical control signal us(t) applied to the electrodes 110, 120 with discrete resonance frequency components or via a resonance frequency spectrum of the electrical drive voltage generated by the stimulating electrical control signal us(t). By means of one (or more) resonance frequency(s), oscillations can be generated in the tempering medium 2. This causes the tempering medium 2 to oscillate and generates heat by increasing the frictional movement of the water molecules, or heat extraction with cooling by reducing the frictional movement of the water molecules. If the molecules of the tempering medium 2 are in oscillation stimulated by the electrical control signal us(t), an acceleration or deceleration of the molecules in the tempering medium 2 occurs accordingly due to the resonance increases in the inverter wave generator, the resulting or reduced frictional energy is converted into heat or cooling. After the tempering medium 2 has passed the electrodes 110, 120, the tempering medium 2 is again swirled over the nozzle plate 150 and its natural oscillations are neutralized or recombined.

Optionally, at least one flow element 160, 160′ can be provided at the inlet opening 40 and/or at the outlet opening 50 of the cell 1 in the cell 1 and/or in the pipe connection piece to the cell 1 in order to support a defined flow of the tempering medium 2. Further flow elements 160, 160′ can advantageously be arranged within the primary circuit 300.

FIG. 2 shows the block diagram of a first preferred embodiment of the arrangement of a signal source 200 for generating a stimulating electrical control voltage us(t) for driving a cell 1. The stimulating electrical control signal us(t) applied to electrodes 110 and 120 of the cell 1 of the inverter wave generator is generated by the signal source 200. In this regard, the signal source 200 comprises a function signal generator 220, an optional filter 230, an amplifier 240, another optional filter 250, and an optional offset source 260.

In this embodiment, the function signal generator 220 generates a periodic output signal having one or more discrete amplitude frequency components and/or having partially continuous amplitude frequency components, such as sinusoidal waveforms or having periodic pulse, square, sawtooth, triangular waveforms, or otherwise periodic waveforms.

The optional filters 230, 250 comprise, for example, in each case at least one low-pass and/or at least one high-pass and/or at least one band-pass with defined filter characteristic with respect to cut-off frequency and quality. The optional filters 230, 250 serve to filter out frequency components which do not contribute to the efficiency of cell 1 of the inverter wave generator from the output signal generated in the function signal generator or to allow frequency components of the output signal generated in the function signal generator which contribute to the efficiency of cell 1 of the inverter wave generator to pass. For example, a low pass filter may pass frequency components up to an upper cut-off frequency and a potentially present DC component, or a high pass filter may suppress low frequency components and a potentially present DC component, or a band pass filter may pass one or more frequency components. In this regard, the optional filter 230, 250 may comprise multiple cascaded filters in series and/or parallel.

Advantageously, the electrical control signal of the function signal generator 220 or the output signal of the optional filter 230 in the amplifier 240 is conditioned with respect to the stimulating electrical voltage amplitude us(t) and the available signal power or the source impedance of the signal source and, if necessary, filtered via the optional filter 250 before it is applied as stimulating electrical control signal us(t) via the poles 211 and 212 (shown in FIG. 1) of the signal source 200 to the electrodes 110 and 120 of the cell 1 of the inverter wave generator.

According to the invention, the repetition frequency of the periodic stimulating electrical control signal us(t) is between 0.1 Hz and 10 kHz. A pulse width of the periodic electrical control signal is in the range between 0.2 μs to 8 s. The amplitude frequency spectrum of the periodic stimulating electrical control signal has spectral components in the range of 0.1 Hz to 10 MHz. The minimum rise time or the minimum fall time of the periodic stimulating electrical control signal is more than 0.01 μs, preferably more than 0.1 μs.

Depending on the state of the tempering medium 2, it may be expedient to apply the stimulating electrical control signal us(t) to the electrodes 110 and 120 of the cell 1 of the inverter wave generator permanently or for a defined time to be specified by the control unit 400 (shown in FIG. 8) with a permanent or defined time-wise unipolar characteristic or with a permanent or defined time-wise bipolar characteristic or with a permanent or defined time-wise partially bipolar characteristic. Optionally, a DC component (offset) generated by the optional offset source 260 is added in or downstream of the amplifier 240 to shift the stimulating electrical control signal us(t) by a defined DC component (offset).

By additive admixing of a DC component (offset), the stimulating electrical control signal us(t) can have a permanent or defined temporary bipolar characteristic or unipolar characteristic or partially bipolar characteristic.

FIG. 2 further shows a primary circuit 300 of the tempering medium 2 and the coupling of the primary circuit 300 of the tempering medium 2 via a heat exchanger 310 to a secondary circuit 320, which operates, for example, a circulating tempering medium 2 for a heating device or a cooling device of a building or a plant.

FIG. 3 illustrates, by way of example, the block diagram of a further embodiment for the arrangement of elements 220, 230, 240, 260, 270 280 within a signal source 200 for generating the stimulating electrical control voltage us(t) for driving a cell 1. In order to raise the stimulating electrical control signal us(t) to a medium to high amplitude value compared to the embodiment example of FIG. 2, a transformer 270 is arranged to transform the AC voltage components of the stimulating electrical control voltage us(t) to defined values. Optionally, a DC component (offset) from an optional offset source 260 is added to the secondary, initially purely bipolar AC voltage components of the transformer 270 to generate the stimulating electrical control signal us(t) with a unipolar characteristic or partially bipolar characteristic.

In another embodiment, an optional rectifier 280 is also arranged on the secondary side of the transformer 270 to convert the secondary initially purely bipolar AC voltage components of the transformer 270 into unipolar AC voltage components having voltage components with alternating unipolar values. In addition, in this embodiment, a DC component (offset) from the optional offset source 260 may be additively mixed in, so as to shift the stimulating electrical control signal us(t) with a unipolar waveform or to produce at least partially bipolar waveforms.

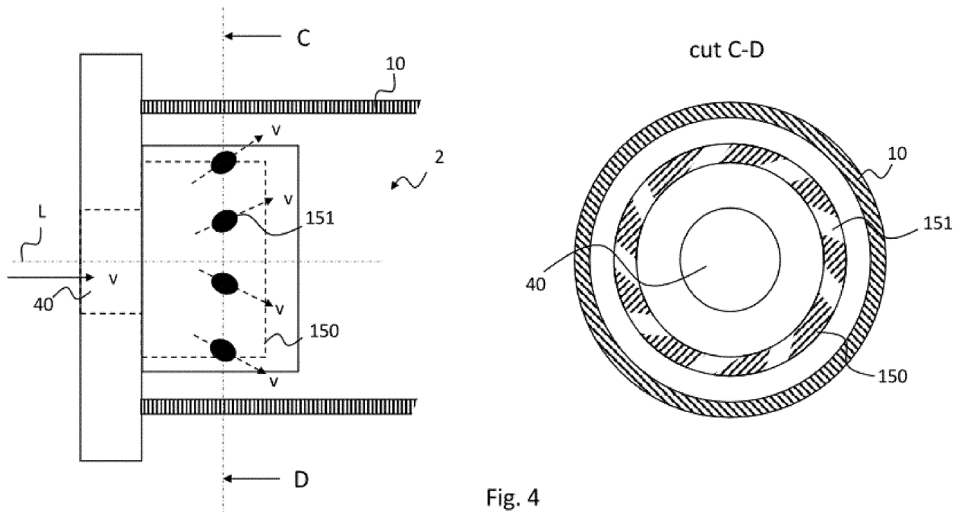

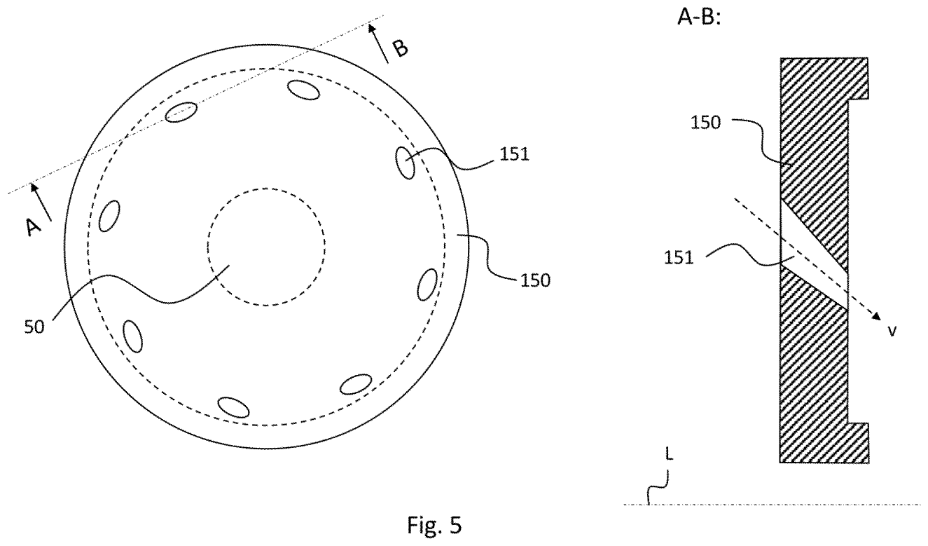

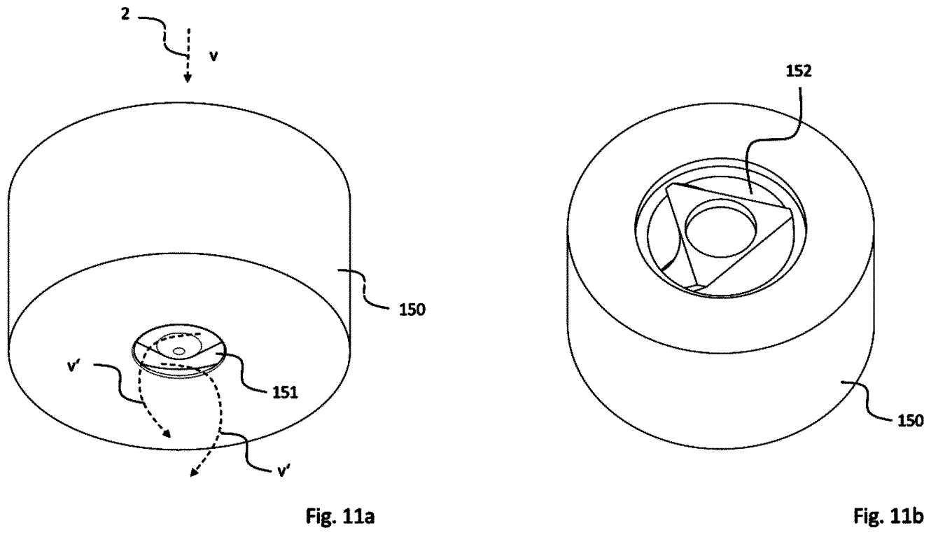

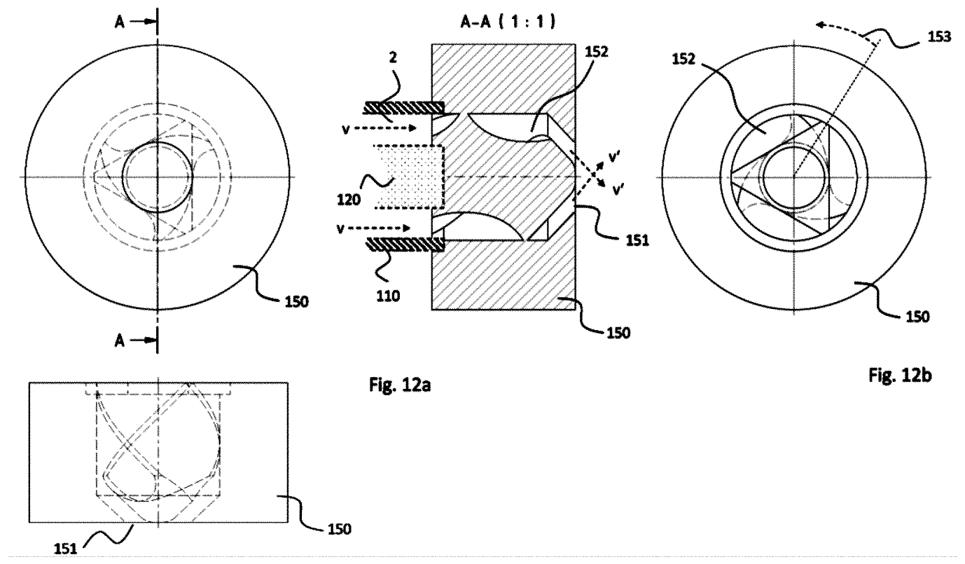

FIG. 4 and FIG. 5 show preferred embodiments of optional nozzle plates 150 with nozzles 151 for swirling the tempering medium 2. Optionally, the nozzle plate 150 can be provided at an inlet opening 40 of a cell 1, which swirls the tempering medium in the flow direction of the tempering medium v in a helical manner, or the nozzle plate 150 can be provided at an outlet opening 50 of the cell 1, which helically swirls the tempering medium in the flow direction of the tempering medium v, or the nozzle plate 150 can be provided at the inlet opening 40 and at the outlet opening 50 of the cell 1, which helically swirls the tempering medium in the flow direction of the tempering medium v. Optionally, the nozzle plate 150 comprises one or more nozzles 151 each having at least one flow channel 152 (shown in FIG. 11b, FIG. 12a and FIG. 12b).

FIG. 4 shows an exemplary side view and top view of the nozzle plate 150 with nozzles 151 arranged laterally in the direction of the longitudinal axis L of the cell 1 in a helically rotated manner, which swirl the tempering medium after entry through the inlet opening 40 in the flow direction of the tempering medium v along the longitudinal axis L of the cell 1, preferably in a helical manner.

FIG. 5 shows an exemplary top view and section A-B of the nozzle plate 150 with nozzles 151 arranged helically along the longitudinal axis L (cf. FIG. 4) of the cell 1, which swirl the tempering medium after it exits through the outlet opening 50 in the flow direction of the tempering medium v along the longitudinal axis L of the cell 1, preferably in a helical manner.

Optionally, the openings and/or the outlet angle of the nozzles 151 can be arranged in the nozzle plate 150 in an adjustable and fixable manner (not shown), for example via a perforated disc that can be rotated relative to the nozzle plate and/or an adjustable pipe section, which control the opening and/or the outlet angles of the nozzles 151. The adjustment can be performed manually or via actuators. The actuators are controlled via the parameter control signals p1 and/or p2, controlled by the controller component r1 and/or r2.

FIG. 6a shows an example of a bipolar frequency spectrum of the stimulating electrical control signal us(t) in terms of a Fourier transformed representation with individual amplitudes of different frequency f1, f2, f3, f4 and bipolar, i.e. changing polarity in the time domain.

FIG. 6b shows the amplitude spectrum f1, f2, f3, f4 in the frequency domain. In the time domain according to the representation in FIG. 6a, the amplitudes of the various exemplary sinusoidal frequency components f1, f2, f3, f4 have a completely bipolar course with respect to a neutral potential, the zero line, i.e. the amplitudes change polarity from plus to minus in the time domain with respect to the neutral potential, the zero line. In the representation in the frequency domain according to FIG. 6b, the complete bipolarity is found again in that no DC component (DC or DC offset) is present in addition to the components f1, f2, f3, f4 in the frequency spectrum.

FIG. 7a shows an example of a unipolar frequency spectrum of the stimulating electrical control signal us(t) in terms of a Fourier transformed representation with individual amplitudes of different frequency f1, f2, f3, f4 and non-changing polarity in the time domain.

FIG. 7b shows the amplitude spectrum in the frequency domain.

In the time domain as shown in FIG. 7a, the amplitudes of the various sinusoidal frequency components f1, f2, f3, f4 in this example have a completely unipolar course with respect to a neutral potential, the zero line, i.e. the amplitudes do not have any changing polarity from plus to minus in the time course with respect to the neutral potential, the zero line.

In the representation in the frequency domain according to FIG. 7b, the unipolarity is represented by a DC component (DC or DC offset) next to the components f1, f2, f3, f4 in the frequency spectrum, which completely shifts the frequency components f1, f2, f3, f4 in this example into a unipolar range. The shift by the DC component can take place in both positive and negative directions, whereby purely positive or purely negative characteristics of the stimulating electrical control signal us(t) occur at the electrodes 110, 120 as an example.

The stimulating electrical control signal us(t) can optionally comprise both a purely unipolar signal mixture and a purely bipolar signal mixture as well as a mixed form of unipolar and bipolar. Optionally, a temporary control for a defined time period at a time can be provided by the control unit 400 (shown in FIG. 8) into a unipolar signal mixture and/or bipolar signal mixture and/or a mixed form of both signal forms.

FIG. 8 shows an example of a preferred embodiment of the block diagram of the decentralized multivariable control unit.

In a preferred embodiment, a control unit 400 is implemented digitally and takes place within an electronic control unit of the inverter wave generator. In this case, the electronic control unit comprises an electronic circuit for realizing a controller 410, advantageously a programmable microcontroller or a signal processor with program memory, data memory and corresponding drivers for the means of a controlled system 420 for setting the parameters, controlled by parameter control signals p1 and/or p2 for controlling the elements of the controlled system 420 (shown in FIG. 9 and FIG. 10) and an interface for programming and updating the program and for accessing data.

The interface may be a wired interface such as a USB interface or an RS232 interface, an Ethernet LAN interface, a WAN interface or a proprietary interface, or a wireless interface such as a Bluetooth interface or a WiFi interface. For programming the electronic control unit of the inverter wave generator, a computer such as a stationary computer or portable computer, a tablet or a smartphone may be used locally. Advantageously, this computer has a further interface to a remote computer or the Internet in order to be able to download ready-made programs or updates for programming the electronic control unit of the inverter wave generator or upload data from there.

In the embodiment of the signal source 200 controlled by a processor via the parameter control signals p1 and/or p2 (shown in FIG. 9 and FIG. 10), the stimulating electrical control signal us(t) is preferably generated by a self-adaptive controller software. Alternatively, other control concepts with dedicated value specifications by an operator and/or a computer are possible. Advantageously, the stimulating electrical control signal us(t) is generated by means of a digital signal processor, on which the control process also runs under the control of a computer program stored in a memory unit of the electronic control unit of the inverter wave generator.

Alternatively or additionally, in a further preferred embodiment, generation and closed-loop control may also be performed by analog means.

In operation, the control unit 400 determines the current temperature Tetaist of the tempering medium 2 using a means for actual value detection 422, and the energy absorbed and the energy delivered are determined. The current efficiency Etaist is determined from the quotient via a means for actual value detection 421. Thereby, a currently achieved efficiency Etaist, also referred to as COP (Coefficient of Performance), is calculated. A defined efficiency Etasoll specified by a means for setpoint setting 411 and/or a defined temperature Tetasoll specified by a means for setpoint setting 412 is aimed for as a setpoint.

The self-adaptive function of the control unit 400 optionally controls, in addition to the characteristics of the stimulating electrical control signal us(t), the properties, in particular the conductivity and/or the pH value and/or the flow rate and/or the pressure of the tempering medium 2 and/or the electrode distance of the electrodes 110, 120 and/or the effective opposing electrode area of the electrodes 110, 120 and/or the nozzle area of the nozzles 151 and/or the outlet angle of the nozzles 151, and continuously makes corrections via the parameter control signals p1 or p2.

The cell 1 of the inverter wave generator is successively driven with the optimal frequency spectrum and the optimal amplitude mix due to the self-adaptive function of the control unit 400. The self-adaptive function of the control unit 400 optionally successively adopts an electrode actuator 140 (shown in FIG. 1) for adjusting the electrode distance and/or the effective opposing electrode area and/or with the dosing pump 304 for the pH value and/or with the conductivity dosing pump and exchange device 303 for the conductivity and/or with a primary circulation pump 302 for the flow rate and/or with the pressure maintaining means 305 for the static pressure of the temperature control medium 2 and/or with an actuator for adjusting the nozzle area of the nozzles 151 and/or with an actuator for adjusting the outlet angle of the nozzles 151 make corrections to the parameter settings.

The efficiency Etaist of the inverter wave generator is determined by the ratio of the thermal energy Eabist delivered to the primary circuit 300 to the electrical control energy Ezuist of the stimulating electrical control signal us(t) supplied to the cell 1 required for this purpose, taking into account all active power frequency components including DC component contained in the stimulating electrical control signal us(t) according to the following relationship:

Etaist=Eabist/Ezuist

The emitted energy Eabist can be determined via the temperature change DeltaTeta [Kelvin] achieved at a defined mass mM [gram] of the tempering medium in the case of water according to the following relationship:

Eabist=mM*DeltaTeta*4.19 [Ws]

The supplied electrical energy is determined with a means for actual value detection of the supplied electrical power Pzuist 423 with a bandwidth of 0 MHz (DC) up to 10 MHz (AC) for inclusion of all harmonic components from the measured supplied control power Pzuist [W] and after integration over the defined measurement period t [seconds], in which the delivered thermal energy Eabist was generated under supply of electrical energy Ezuist. The measurement of the supplied electrical energy Ezuist is thus performed approximately according to the following relationship, taking into account the DC component and all harmonic components of the supplied active control power Pzuist [W] to be measured:

Ezuist=Pzuist*t [Ws]

In the case of values of the supplied electrical power Pzuist changing within a measurement period t, which, for example, follow a time-varying curve progression pzuist(t), advantageously instead of a simple area formation for Ezuist by a multiplication Pzuist*t [Ws], a more precise integration of a curve progression pzuist(t)*dt [Ws] can be carried out over the period of the measurement period in order to determine the supplied electrical energy Ezuist.

In operation, the control unit 400 monitors the current temperature Tetaist of the temperature control medium 2 in the primary circuit 300 by means of the means for actual value detection 422. The means for actual value detection 422 comprises, for example, a temperature sensor with which a change in the temperature DeltaTeta in the temperature Tetaist of the temperature control medium 2 is determined in the course of a measuring period t. The means for actual value detection 422 optionally comprises several temperature sensors with which a change in the temperature DeltaTeta in the temperature Tetaist of the temperature control medium 2 is determined by difference formation and/or by weighted evaluation of the individual temperature measured values. Optionally, the means for actual value detection 422 comprises several temperature sensors, with which a change in the temperature DeltaTeta in the temperature Tetaist of the temperature control medium 2 is determined in the course of a measurement period t by difference formation and/or by weighted evaluation of the individual temperature measurement values. From this, the delivered energy Eabist and the current efficiency Etaist are determined according to the relationship Eabist=mM*DeltaTeta*4.19 [Ws] and/or optionally via the means for actual value detection 421. The means for actual value detection 421 optionally comprises a heat meter, for example. The calculation of the current efficiency Etaist is performed, for example, via a computer program sequence or via an analog quotient formation. A temperature Tetasoll specified via the means for setpoint specification 412 and/or a defined efficiency Etasoll specified via the means for setpoint specification 411 is aimed for. The continuously determined temperature Tetaist and/or the continuously determined efficiency Etaist represent the actual values for the controller.

The targeted defined temperature Tetasoll of the heating/cooling in the primary circuit 300 with the tempering medium 2 and/or optionally a specific time profile for a change in this value and/or the targeted defined efficiency Etasoll and/or optionally a specific time profile for a change in this value provide the setpoint settings Tetasoll and/or Etasoll for the controller 410. Both variables are advantageously processed, for example, by a decentralized control for multivariable systems. Alternatively, other control concepts are possible.

The difference between the setpoint Tetasoll and/or Etasoll and the corresponding actual value Tetaist and/or Etaist provides the control deviation d1 or d2 in the controller 410. This forms the criterion for controlling the controlled system 420 by the controller component r1 and/or controller component r2. The controller component r1 and/or controller component r2 determines the characteristics of the controller 410, for example a P-behavior, an I-behavior or a D-behavior or mixed forms of the controller 410, and provides the parameter control signal p1 and/or parameter control signal p2 for controlling the parameter settings of the controlled system 420. The controlled system 420 changes the parameter settings of, for example, the function signal generator 220, the optional filter 230 or the optional filter 250 (shown in FIG. 2), the optional offset source 260 of the amplifier 240, the signal source 200 (shown in FIG. 9), the sinus signal generators 221, 221′, an optional offset source 222, a mixer 223 of the amplifier 240, the signal source 200 (shown in FIG. 10), the primary circuit pump 302, the conductivity dosing pump and exchange device 303, a pH dosing pump 304, the electrode actuator 140, a pressure-maintaining device 305 or the nozzle plate actuator on the basis of the controlling specifications via the parameter control signals p1 or p2 of the respective controller component r1 and/or r2.

Summary of the Function of the Control Unit:

During operation, the control unit 400 detects the current temperature Tetaist of the tempering medium 2 in the primary circuit 300 via the means for actual value detection 422 and/or the current efficiency Etaist of the inverter wave generator via the means for actual value detection 421 or from the change in the temperature Tetaist of the tempering medium 2 in the primary circuit 300, takes the value of a desired temperature Tetasoll of the temperature of the tempering medium 2 in the primary circuit 300 from the means for the setpoint setting 412 for the specifications of the desired temperature Tetasoll of the temperature of the tempering medium 2 in the primary circuit 300 and/or takes the value of a desired efficiency Etasoll of the inverter wave generator from the means for setpoint setting 411 for the specifications of the desired efficiency Etasoll of the inverter wave generator. the value of a desired efficiency Etasoll and forms the control deviation d1 or d2 in a controller 410 from the difference between the desired value Tetasoll and the actual value Tetaist and/or from the difference between the desired value Etasoll and the actual value Etaist and forms a parameter control signal p1 and/or a parameter control signal p2 in the controller 410 by a controller component r1 and/or a controller component r2, with which a controlled system 420 can be controlled in such a way that the control deviation d1 and/or d2 successively tends towards zero or is eliminated. In this regard, the controlled system 420 in operation allows the parameter settings of the function signal generator 220 and/or the optional filter 230 and/or the optional filter 250 and/or the sinusoidal signal generators 221, 221′ and/or of an optional offset source 222 and/or of a mixer 223 and/or of the optional offset source 260 and/or of the amplifier 240 of the signal source 200 and/or of the primary circuit pump 302 and/or of the conductivity metering pump and exchange device 303 and/or of the pH value dosing pump 304 and/or of the electrode actuator 140 and/or of the pressure maintaining device 305 and/or of the nozzle plate actuator on the basis of the controlling presets via the parameter control signal p1 of the controller component r1 and/or via the parameter control signal p2 of the controller component r2 in such a manner that the control deviation d1 and/or d2 successively tends towards zero or is eliminated.

The control unit 400 may be analog and/or at least partially digital in the electronic control unit of the inverter wave generator.

The control unit may be of conventional or self-adaptive design.

According to the invention, two embodiments for the controlled system 420 are distinguished: The controlled system with analytical signal generation or the controlled system with synthetic signal generation.

FIG. 9 shows a preferred embodiment example for the analog and/or digital controlled system with analytical signal generation. In this embodiment of the inverter wave generator, the generation of the periodic stimulating electrical control signal us(t) with a defined harmonic spectrum, for example a pulse-shaped signal with defined unipolarity or defined bipolarity or defined partial bipolarity with defined repetition frequency, pulse width, edge steepness and an amplitude and impedance determined by the amplifier 240, a filtering in the optional filter 230 and optionally by mixing in an offset from an optional offset source 260, takes place in a signal source 200. The harmonics of the stimulating electrical control signal us(t) at electrodes 110, 120 of a cell 1 are in a frequency range from 0 Hz up to 10 MHz. The generation of the stimulating electrical control signal us(t) and optionally the filtering is analog and/or advantageously at least partially digital.

In this embodiment, a controlled system 420 changes parameter settings of, for example, a function signal generator 220, an optional filter 230, or an optional filter 250 (shown in FIG. 2), an optional offset source 260, an amplifier 240 of the signal source 200, a primary circuit pump 302, a conductivity dosing pump and exchange device 303, a pH value dosing pump 304, an electrode actuator 140, a pressure-maintaining device 305 or a nozzle plate actuator on the basis of the controlling specifications via the parameter control signals p1 or p2 of the respective controller component r1 and/or r2.

The absorbed electrical energy Ezuist is determined from the electrical power Pzuist 423 supplied by the means for actual value detection of the entire frequency spectrum contained in the stimulating electrical control signal us(t) and the DC component by integration over the time of the measuring period. In the primary circuit, actual value detection means 422 are provided for detecting the actual temperature Tetaist and actual value detection means 421 are provided for detecting the delivered thermal energy Eabist.

The static pressure in the primary circuit 300 is controllable in a defined manner via the pH value dosing pump 304 and/or via the conductivity dosing pump and the exchange device 303 and/or the pressure-maintaining device 305, such as a controllable pressure vessel or a controllable pressure valve.

The parameter setting of the controlled system 420 via the parameter control signals p1 and/or p2 is performed in this embodiment of the signal generation of the inverter wave generator
by changing the curve function of the signal generated by the signal source 200 and/or the repetition frequency and/or the pulse width and/or the rise time and/or the fall time and/or the amplitude of the stimulating electrical control signal us(t) applied to the electrodes 110, 120 of the cell 1,
by a permanently or defined temporarily unipolar alignment of the polarity without alternation of polarity applied to the electrodes 110, 120 of the cell 1 of the inverter wave generator, or permanently or defined temporarily bipolar alignment of the polarity with an alternation of polarity, or permanently or defined temporarily partially bipolar alignment of the polarity with a partial alternation of polarity of the stimulating electrical control signal us(t),
optionally on the basis of the parameters of the optional filter 230, 250 (see FIG. 2) for a respective lower cut-off frequency and/or a respective upper cut-off frequency and/or a respective Q of the at least one optional filter 230, 250, wherein the optional filter 230, 250 may comprise a plurality of parallel and/or series cascaded filters and higher order filters and wherein the optional filter 230, 250 is arranged in the signal path between the output of the function signal generator 220 serving as an electrical signal source and the electrodes 110, 120 of the cell 1,
optionally, when using the amplifier 240, by means of the amplifier setting for the amplitude and optionally by controlling a DC component (offset) from the optional offset source 260 of the stimulating electrical control signal us(t) applied to the electrodes 110, 120 of the cell 1,
optionally by changing the pH value in the tempering medium 2, the defined pH value being readjusted via the dosing pump 304, which is operated in the primary circuit 300 by drawing off tempering medium 2 and/or adding water with a pH value of 6.91 to 7.09 and/or adding acid with a pH value of 1 to 6.90 and/or adding alkali with a pH value of 7.1 to 14 from tank containers arranged outside the device of the inverter wave generator in each case and suitable for these fluids, readjusts the desired setpoint value of the pH value,
optionally by changing the conductivity in the tempering medium 2, the defined conductivity of the tempering medium 2 being readjusted via the conductivity dosing pump and the exchange device 303, in that in the primary circuit 300, by drawing off tempering medium 2 and/or adding water with a conductivity of 0.055 μS/cm to 500 μS/cm, in particular of 0.1 μS/cm to 100 μS/cm and preferably of 10 μS/cm to 50 uS/cm, in a particularly preferably manner with values of 20 μS/cm to 30 μS/cm or by adding water with a conductivity of 0.05 S/m to 200 S/m, in particular of 0.05 S/m to 5 S/m and preferably of 0.05 S/m to 0.5 S/m from tank containers arranged in each case outside the device of the inverter wave generator and suitable for these fluids, the desired setpoint value of the conductivity in the primary circuit 300 is readjusted,
optionally by changing the electrode distance and/or the electrode area of the electrodes 110, 120, for example via the electric, hydraulic, pneumatic, magnetic or piezoelectric electrode actuator 140,
optionally by changing the flow rate of the tempering medium 2 in the primary circuit 300 and thus in the cell 1, for example by changing the pump speed of the primary circuit pump 302 in the primary circuit or by changing the cross-section in the primary circuit 300,
optionally by changing the static pressure and/or the dynamic pressure of the tempering medium 2 in the primary circuit 300 and thus in the cell 1, for example by changing the pump speed of the primary circuit pump 302 in the primary circuit 300 or by changing the cross-section in the primary circuit 300 and/or by drawing off and/or admixing tempering medium 2 by the pH-value dosing pump 304 and/or by the conductivity dosing pump and the exchange device 303 and/or by changing the response pressure of the pressure-maintaining device 305,
optionally by intermittently timing the parameter control signals p1 and/or p2 to control frequency generation, amplitude control and/or phase control and/or filtering and/or electrode distance and/or electrode area and/or flow rate and/or pH and/or conductivity and/or static pressure and/or dynamic pressure of the tempering medium 2 and/or swirling by controlling the nozzle plate actuator of the nozzles 151 of the nozzle plate 150.

FIG. 11 shows a perspective view of a nozzle plate as seen from below.

In this embodiment, the nozzle plate 150 comprises a single nozzle 151 from which the tempering medium 2 exits with swirled flow vectors v′. The swirling of the tempering medium 2 is generated by at least one flow channel 152 (shown in FIG. 11b) within the nozzle plate 150.

FIG. 11b shows the perspective view of the nozzle plate from FIG. 11a as seen from above. The nozzle plate 150 comprises three flow channels 152, into which the tempering medium 2 enters and is swirled within the nozzle plate 150.

FIG. 12a shows a nozzle plate according to FIG. 11a and FIG. 11b in the view from below, a section AA from the side and in the front view.

In this embodiment, the nozzle plate 150 comprises three flow channels 152, in which the inlet opening is offset relative to the outlet opening by a flow channel rotation angle 153 of at least 1 degree, and a flow channel 152 passes from the inlet opening to the outlet opening in a stepped or continuous manner, as a result of which a tempering medium 2 flowing therethrough undergoes a rotation of at least 1 degree in the nozzle plate 150, which rotation can continue in a spiral shape in the primary circuit 300 after leaving the nozzle plate 150.

The flow channel rotation angle 153 can comprise from 1 degree to several helical rotations of 360 degrees each. Advantageously, the twisting of the flow channels is optionally embodied manually or adjustable via an actuator.

Advantageously, the nozzle plate 150 comprises a plurality of flow channels 152 arranged in parallel, in which the inlet opening is offset by at least 1 degree relative to the outlet opening and the flow channel 152 passes from the inlet opening in a stepped or continuous helical manner to the outlet opening, as a result of which a tempering medium 2 flowing through undergoes a rotation of at least 1 degree in the nozzle plate 150, which rotation can continue in a helical manner in the primary circuit 300 after leaving the nozzle plate 150.

The rotation of the flow channels 152 can comprise from 1 degree to several helical rotations of 360 degrees each. Advantageously, the rotation of the flow channels is optionally embodied to be adjustable manually or via an actuator.

The nozzle plate 150 of the illustrated embodiment may comprise adjustable flow elements (not shown), the openings and/or angles of which are adjustable relative to the surface of the nozzle plate 150. In this regard, the opening and/or outlet angle of the nozzle may be arranged in the nozzle plate 150 in an adjustable and fixable manner, for example via a perforated disc (not shown) that is rotatable with respect to the nozzle plate 150 and/or an adjustable tubular piece (not shown), which control the opening and/or outlet angles of the nozzles that are helical in the flow direction.

The nozzle plate 150 comprises solid material, for example metal, plastic, or glass. Advantageously, the material of the nozzle plate 150 may alternatively or additionally comprise elastic material, such as permanently elastic plastic, rubber, silicone, or a metallic spring or a spring made of plastic, whereby the openings of the flow channels 152 and/or the angle of one or more flow channels 152 relative to the surface of the nozzle plate 150 are adjustable by deforming the material of the nozzle plate 150.

The adjustment can be performed manually and/or via actuators, for example by the electric, pneumatic, hydraulic or magnetic nozzle plate actuator. The actuators are advantageously controlled by parameter settings via the parameter control signals p1 and/or p2, controlled by the controller component r1 and/or r2, in such a way that controlled swirling can take place, with which, in synergy with the other parameter settings, the set temperature Tetasoll and/or the set efficiency Etasoll can be successively set in the course of the control cycle.

Optionally, the nozzle plate 150 in the embodiments mentioned with at least one flow channel 152 or with several flow channels 152 closes the space between the electrodes 110, 120 in such a way that the tempering medium 2 is guided between the electrodes 110, 120 when circulating in the primary circuit 300.

By swirling the tempering medium 2 between the electrodes 110, 120 of the cell 1, the effect of the stimulating electrical control signal us(t) on the molecules or the molecule clusters of the tempering medium 2 is increased, because the total number of molecules or molecule clusters flowing past the electrodes 110, 120 and the number of molecules or molecule clusters not yet stimulated and yet to be stimulated flowing past the electrodes 110, 120 is increased. Furthermore, the recombination of stimulated molecules or molecule clusters of the tempering medium 2 in the primary circuit 300 is further supported.

FIG. 12b shows the top view of the nozzle plate from FIG. 11a, FIG. 11b and FIG. 12a.

In particular, an exemplary flow channel rotation angle 153 between the inlet of the tempering medium into a flow channel 152 of the nozzle plate 150 and the outlet of the flow channel 152 from the nozzle plate 150 is shown.

FIG. 10 shows a preferred embodiment of an analog controlled system and/or a digital controlled system with synthetic signal generation. Here, the generation of a stimulating electrical control signal us(t) in a signal source 200 is performed by synthesizing individual sinus signals from individual sinus signal generators 221, 221′ with defined frequency, amplitude and phase relation to each other and optionally a DC component from an optional offset source 222 by mixing in the mixer 223 and by amplifying the resulting signal in the amplifier 240.

In the case of the advantageous digital generation and filtering, the individual signal values are present as temporally discrete digital quantities, which are calculated by a processor in the electronic control unit of the inverter wave generator, which is controlled by a computer program stored there. The individual digital signal values each represent a signal with a defined time curve of the signal amplitude. The resulting signal thus follows a defined periodic function and its derivatives as a function of time, for example rectangle, pulse, triangle, sawtooth, sine or another periodic curve.

Several sinusoidal signals with defined frequency and amplitude calculated by the individual digital sinus signal generators 221, 221′ are mutually assigned to each other in the respective phase position of the signals. A mixing of the digital signal values to a common signal value is performed in a computational mixing operation in the digital mixer 223.

The calculation of temporally discrete values of the waveform is advantageously performed in the processor of the electronic control unit of the inverter wave generator. This waveform generates the frequency spectrum defined by the controller component r1 and/or the controller component r2 with respect to the respective frequency, amplitude and phase position.

Optionally, controlled by the controller component r1 and/or the controller component r2, a DC component from the optional offset source 222 can be added permanently or temporarily for a defined duration in order to shift the stimulating electrical control signal us(t) partially into the positive range or negative range, for example, to compensate for any undesired DC components or to add an additional DC component to the stimulating control signal.

In the case of digital generation, the result is converted from the digital value to an analog signal in a digital to analog (D/A) converter (not shown) within the function signal generator 220 and, after amplification in the amplifier 240, is supplied as a stimulating electrical control signal us(t) to the electrodes 110, 120 of the cell 1 of the inverter wave generator. The amplifier 240 processes the signal from the function signal generator 220 in electrical amplitude and power, which is applied either directly or translated via the transformer 270 (cf. FIG. 3) as stimulating electrical control signal us(t) to the electrodes 110, 120 of cell 1 of the inverter wave generator.

In the analog embodiment, the generation of the input signal of the amplifier 240 in the signal source 200 is carried out, for example, by the analog or digitally controllable sinus signal generators 221, 221′ and the analog mixer 223 within the function signal generator 220. Advantageously, the analog signal is fed to the inlet of the controllable amplifier 240, which processes the input signal in electrical amplitude and power and thus outputs it either directly or translated via the transformer 270 (cf. FIG. 3) as a stimulating electrical control signal us(t) to the electrodes 110, 120 of the cell 1 of the inverter wave generator.

Optionally, a DC component can be added to shift an initially purely bipolar signal partially into the positive or negative range, for example to compensate for any undesired DC components or to add an additional DC component to the stimulating control signal. Advantageously, the analog signal is fed to the inlet of the analog amplifier 240, which is controllable with respect to gain factor, and which processes the signal in amplitude and power and thus transmits it either directly or translated via the transformer 270 (cf. FIG. 3) as a stimulating electrical control signal us(t) to the electrodes 110, 120 of the cell 1 of the inverter wave generator. If the transformer 270 is used, a DC component can optionally be added at the inlet of the cell 1 of the inverter wave generator.

The frequency of the stimulating electrical control signal us(t) at electrodes 110, 120 of cell 1 ranges from 0 Hz up to 10 MHz. This frequency range provides the surprising effect of influenceability with high efficiency of more than 100% by the stimulating electrical control signal us(t) for temperature control of water molecules, because a thermal influenceability of the water dipoles is known so far only from the range of microwaves of more than 2 GHz with an efficiency around 60%.

The parameter setting of the controlled system 420 via the parameter control signals p1 and/or p2 takes place in this embodiment of the signal generation of the inverter wave generator
by the generation of at least one sinusoidal signal in each case by the individual sinus signal generators 221, 221′ with a defined frequency and amplitude predetermined by the controller component r1 and/or r2,
in the case of a plurality of such sinusoidal individual signal components, by the defined individual frequencies specified by the controller component r1 and/or r2 to the individual sinusoidal signal generators 221, 221′ and by specified individual defined amplitudes and by specified individual defined phase positions of the individual signals relative to one another,
in the case of a plurality of signals generated by individual sinus signal generators 221, 221′, by mixing the individual signals in an optionally controllable mixer 223,
by the stimulating electrical control signal us(t) applied to the electrodes 110, 120 of the cell 1 of the inverter wave generator with a permanent or defined time-defined unipolarity without alternation of polarity or with a permanent or defined time-defined bipolarity with alternation of polarity or a permanent or defined time-defined at least partial bipolarity with an at least partial alternation of polarity,
optionally, when using the amplifier 240, by means of the amplifier setting for the amplitude of the signal applied to the electrodes 110, 120 of the cell 1,
optionally by changing the pH in the tempering medium 2, the defined pH being readjusted via the dosing pump 304 by drawing off tempering medium 2 in the primary circuit 300 and/or adding water having a pH of 6.91 to 7.09, and/or adding acid with a pH value of 1 to 6.90, and/or adding alkali with a pH value of 7.1 to 14 from tank containers suitable for these fluids, each arranged outside the device of the inverter wave generator,
optionally by changing the conductivity in the tempering medium 2, the defined conductivity of the tempering medium 2 being readjusted via the conductivity dosing pump and the exchange device 303, by drawing off tempering medium 2 in the primary circuit 300 and/or adding water having a conductivity of 0.055 μS/cm to 500 μS/cm, in particular of 0.1 μS/cm to 100 μS/cm and preferably of 10 μS/cm to 50 μS/cm, particularly preferably by values of 20 μS/cm to 30 μS/cm or by adding water with a conductivity of 0.05 S/m to 200 S/m, in particular of 0.05 S/m to 5 S/m and preferably of 0.05 S/m to 0.5 S/m, from tank containers suitable for these fluids, each arranged outside the device of the inverter wave generator, the desired setpoint value of the conductivity is readjusted and produced,
optionally by changing the electrode distance and/or the electrode area of the electrodes 110, 120, for example via at least the electric, hydraulic, pneumatic, magnetic or piezoelectric electrode actuator 140,
optionally by changing the flow rate of the tempering medium 2 in the primary circuit 300 and thus in the cell 1, for example by changing the pump speed of the primary circuit pump 302 in the primary circuit 300 or by changing the cross-section in the primary circuit 300,
optionally by changing the static pressure and/or dynamic pressure of the tempering medium 2 in the primary circuit 300 and thus in the cell 1, for example by changing the pump speed of the primary circuit pump 302 in the primary circuit 300 or by changing the cross-section in the primary circuit 300 and/or by suction and/or by admixing tempering medium 2 by the pH-value dosing pump 304 and/or by the conductivity dosing pump and exchange device 303 and/or by changing the response pressure of the pressure-maintaining device 305,
optionally by intermittently timing the parameter control signals p1 and/or p2 to control the frequency generation, amplitude control and/or phase control and/or filtering and/or electrode distance and/or electrode area and/or flow rate and/or pH and/or conductivity and/or static pressure and/or dynamic pressure of the tempering medium 2 and or the nozzle plate actuator of the nozzles 151 of the nozzle plate 150.

Alternative embodiments comprise both in the controlled system 420 with analytical signal generation and in the controlled system 420 with synthetic signal generation in the analog or digital embodiment, for example already during signal generation in the function signal generator 220 or in the signal path thereafter by mixing in a DC component or an offset from an optional offset generator 222, 260 for the stimulating electrical control signal us(t) applied to the electrodes 110, 120 of the cell 1 of the inverter wave generator permanently or defined temporarily unipolar course and/or permanently or defined temporarily bipolar course or defined temporarily partial bipolar course. Optionally, the stimulating electrical control signal us(t) can be completely suspended for defined time intervals or partially suspended, for example by lowering the amplitude, in order to enable recombination of the tempering medium 2 during pause times, for example.

Both in the controlled system 420 with analytical signal generation and in the controlled system 420 with synthetic signal generation, the controller 410 is advantageously implemented in the electronic control unit of the inverter wave generator by a processor, in particular a signal processor with a program stored in the electronic control unit of the inverter wave generator for controlling the method steps according to the invention, taking into account the detected actual values and the predetermined setpoint values.

Although the control cycles are relatively slow in the range of several seconds to minutes, since the detection of the actual value for the partially thermally determined efficiency Etaist is relatively sluggish, a clock frequency of over 100 MHz of the processor is also advantageous with regard to signals to be digitally generated with regard to the cut-off frequency of the harmonics to be processed of the stimulating electrical control signal us(t) at the electrodes 110, 120 of cell 1 of up to 10 MHz in order to avoid aliasing effects. The slow control cycles do not pose a problem in the context of a heating/cooling system.

The parameter combinations are set under program control in the defined method steps by successive variation of the parameter settings.

Advantageously, both in the embodiment of the controlled system 420 with analytical signal generation and in the embodiment of the controlled system 420 with synthetic signal generation, the variation of the parameter setting can be performed on the basis of randomized methods such as, for example, a so-called Monte Carlo algorithm or a so-called Las Vegas algorithm or the like.

Parameter settings which have been carried out successfully and, if necessary, also unsuccessfully, depending on the method, and their initial situation are advantageously stored in a memory device of the electronic control unit of the inverter wave generator and, depending on the initial situation, are later selected again with higher priority and stored again if successful. In this way, the control unit 400 “learns” from its previous successfully and possibly also unsuccessfully performed parameter settings and can thus successively optimize itself and the control unit for successful parameter settings for generating the stimulating control signal depending on the dimensions of the inverter wave generator and depending on its operating conditions.

The control unit 400 can advantageously have a self-adaptive function, whereby the control unit 400, in addition to the properties of the stimulating electrical control signal us(t), monitors the condition, in particular the conductivity and/or the flow rate and/or the pressure of the tempering medium 2 and/or the electrode distance of the electrodes 110, 120 and/or the effectively opposing electrode area of the electrodes 110, 120 and/or the nozzle area of the nozzles 151 and/or the outlet angle of the nozzles 151, and continuously makes corrections via the parameter control signals p1 and/or p2, in that successfully and/or unsuccessfully performed parameter settings and their initial situation are stored in a memory device of the device and are selected at a later time with higher priority and optionally stored again if successful.

For the implementation, both in the embodiment of the controlled system 420 with analytical signal generation and in the embodiment of the controlled system 420 with synthetic signal generation, conventional controllers and/or advantageously also so-called “fuzzy controllers” can be used for the controller 410, which, in contrast to narrowly tolerated values, enable the use of widely tolerated “fuzzy” value ranges. “Fuzzy controllers are advantageously suited for implementing the technical process with optionally several input and output variables with changing mutually influencing parameters and non-linear subsystems.

Via the self-learning function, the control unit 400 advantageously optimizes itself independently. If the efficiency Etaist and/or the temperature Tetaist deviate from the setpoint values Etasoll or Tetasoll during operation, the parameter settings are successively varied and readjusted via the parameter control signal p1 and/or p2 until the deviation tends towards zero or is eliminated. This is a continuous cybernetic method which takes place during the entire operation.

Advantageously, parameter sets already successfully determined for a defined embodiment of the inverter wave generator are optionally stored as start values for commissioning the control unit 400.

Alternatively, a conventional control unit 400 operating according to cybernetic principles and possibly not self-learning can be used.

The controller 410 advantageously adjusts the heating output to the predetermined setpoints for Tetasoll and/or Etasoll, so that modulating operation occurs and exactly the heat or cold is produced that is needed.

The operation of an inverter wave generator for temperature control of a tempering medium 2 is basically carried out in the following method steps in the embodiments described:
providing an inverter wave generator with the described features, whereby
a tempering medium 2 is moved in a primary circuit 300,
in the process, the tempering medium 2 in the primary circuit 300 is fed to a cell 1 comprising a first electrode 110 and a second electrode 120
a stimulating electrical control signal us(t) is applied to the electrodes 110, 120 in direct electrical contact with the tempering medium 2, whereby
the tempering medium 2 in the cell 1 between the electrodes 110, 120 is subjected to an electric field which influences the orientation of the particles of the tempering medium 2 according to their polarity and thereby changes the temperature Tetaist of the tempering medium 2 in the primary circuit 300,
the tempering medium 2 in the primary circuit 300 is fed to the inlet of a heat exchanger 310 and at least partially releases thermal energy in the heat exchanger 310 to the outlet of the heat exchanger 310.

Alternatively, the method of transmitting the electric field from the electrodes 110, 120 to the tempering medium 2 can be carried out capacitively, without direct electrically conductive contact between the electrodes 110, 120 and the tempering medium 2 in the following method steps:
providing an inverter wave generator having the features described, wherein
a tempering medium 2 is moved in a primary circuit 300,
the tempering medium 2 is supplied in the primary circuit 300 to a cell 1 comprising a first electrode 110 and a second electrode 120,
a stimulating electrical control signal us(t) is applied to the electrodes 110, 120 without direct electrical contact to the tempering medium 2, whereby
the tempering medium 2 in the cell 1 between the electrodes 110, 120 is subjected to an electric field which influences the orientation of the particles of the tempering medium 2 according to their polarity and thereby changes the temperature Tetaist of the tempering medium 2 in the primary circuit 300,
the tempering medium 2 in the primary circuit 300 is fed to the inlet of a heat exchanger 310 and at least partially releases thermal energy in the heat exchanger 310 to the outlet of the heat exchanger 310.

It is understood that the above description of preferred embodiments is exemplary only, and that various modifications may be made by those skilled in the art. Although various embodiments have been described above with some degree of precision, or with reference to one or more individual embodiments, those skilled in the art could make numerous modifications to the disclosed embodiments without departing from the essence or scope of protection of this invention. Aspects of any of the examples described above may be combined with aspects of any other examples described to form further examples without losing any effect.

### LIST OF REFERENCE SIGNS USED

1 cell
2 tempering medium
10 housing
40 inlet opening
50 outlet opening
110 first electrode
120 second electrode
140 electrode actuator
150 nozzle plate
151 nozzle
152 flow channel
153 flow channel rotation angle
160, 160′ flow element
200 electrical signal source
211, 212 pole of electrical signal source
220 function signal generator
221, 221′ sinus signal generator
230, 250 optional filter
240 amplifier
222, 260 optional offset source
223 mixer
270 transformer
280 optional rectifier
300 primary circuit
302 primary circuit pump
303 conductivity dosing pump and exchange device
304 pH value dosing pump
305 pressure-maintaining device
310 heat exchanger
320 secondary circuit
400 control unit
410 controller
411, 412 means for setpoint setting
420 controlled system
421, 422 means for actual value detection
423 means for actual value detection of supplied electrical power Pzuist
p1, p2 parameter control signal
r1, r2 controller component
us(t) stimulating electrical control signal
v low direction of the tempering medium
v′ swirled flow direction of the tempering medium
L longitudinal axis of cell 1

1.-26. (canceled)

27. An inverter wave generator comprising:
a tempering medium (2),
a cell (1) for tempering the tempering medium (2) which comprises dipolar particles,
a housing (10) with at least one inlet opening (40) and at least one outlet opening (50) for the tempering medium (2),
at least one first electrode (110) and
at least one second electrode (120) being arranged in the housing (10) at a distance from one another,
wherein the at least first electrode (110) and the at least second electrode (120) are each electrically conductively connected to a pole (211, 212) of at least one electrical signal source (200), and
wherein the tempering medium (2) has a conductivity in a range of 0.055 μS/cm to 500 μS/cm.

28. The inverter wave generator according to claim 27,
wherein the heat transfer medium (2) has a conductivity in a range from 0.1 μS/cm to 100 μS/cm.

29. The inverter wave generator according to claim 27,
wherein the distance between the electrodes (110, 120) is variable in a defined manner.

30. The inverter wave generator according to claim 27,
wherein an opposing area of the electrodes (110, 120) between the electrodes (110, 120) is variable in a defined manner.

31. The inverter wave generator according to claim 30,
wherein the distance of the electrodes (110, 120) and/or the area of the electrodes (110, 120) can be varied in a defined manner via at least one electrode actuator (140).

32. The inverter wave generator according to claim 27,
wherein the cell (1) comprises a nozzle plate (150) at the inlet opening (40) and/or at the outlet opening (50), which has at least one nozzle (151) for swirling the tempering medium (2).

33. The inverter wave generator according to claim 32,
wherein the nozzle plate (150) closes off a space between the electrodes (110, 120) in such a way that the tempering medium (2) is guided between the electrodes (110, 120) when circulating in the primary circuit (300).

34. The inverter wave generator according to claim 33,
wherein the nozzle plate (150) closes off the space between the electrodes (110, 120) in such a way that the tempering medium (2) is guided between the electrodes (110, 120) when circulating in the primary circuit (300).

35. The inverter wave generator according to claim 27,
wherein the cell (1) has flow elements (160, 160′) at the inlet opening (40) and/or at the outlet opening (50).

36. The inverter wave generator according to claim 27,
wherein the signal source (200) generates a stimulating electrical control signal us(t) having amplitude components in a frequency spectrum of 0 Hz to 10 MHz.

37. The inverter wave generator of claim 36,
wherein the stimulating electrical control signal us(t) has a periodic signal sequence with a repetition frequency of 0.1 Hz to 10 kHz.

38. The inverter wave generator of claim 37,
wherein the stimulating electrical control signal us(t) has a pulse width of 0.2 μs to 8 s.

39. The inverter wave generator of claim 38,
wherein the stimulating electrical control signal us(t) has a minimum rise time of greater than 0.01 μs and a minimum fall time of greater than 0.01 μs.

40. The inverter wave generator according to claim 36,
wherein the stimulating electrical control signal us(t) has a defined unipolarity without alternation of polarity.

41. The inverter wave generator according to claim 36,
wherein the stimulating electrical control signal us(t) has a defined bipolarity with alternation of polarity.

42. The inverter wave generator according to claim 36,
wherein the stimulating electrical control signal us(t) has partial bipolarity with partial alternation of polarity.

43. The inverter wave generator according to claim 36,
wherein the amplitude of the stimulating electrical control signal us(t) has a value from 1 V peak-to-peak to 100 kV peak-to-peak as a function of the conductivity of the tempering medium (2) and of the distance of the electrodes (110, 120) and of the electrode area of the electrodes (110, 120).

44. The inverter wave generator according to claim 43,
wherein the amplitude of the stimulating electrical control signal us(t) has a value from 1 V peak-to-peak to 60 V peak-to-peak depending on the conductivity of the tempering medium (2) and on the distance of the electrodes (110, 120) and on the electrode area of the electrodes (110, 120).

45. The inverter wave generator according to claim 43,
wherein the amplitude of the stimulating electrical control signal us(t) has a value from 60 V peak-to-peak to 1000 V peak-to-peak depending on the conductivity of the tempering medium (2) and on the distance of the electrodes (110, 120) and on the electrode area of the electrodes (110, 120).

46. The inverter wave generator according to claim 43,
wherein the amplitude of the stimulating electrical control signal us(t) has a value from 1000 V peak-to-peak to 100 kV peak-to-peak depending on the conductivity of the tempering medium (2) and on the distance of the electrodes (110, 120) and on the electrode area of the electrodes (110, 120).

47. A system for an inverter wave generator, comprising:
a cell (1),
a signal source (200) for generating a stimulating electrical control signal us(t),
a primary circuit (300), wherein the primary circuit (300) leads a tempering medium (2) from the cell (1) to an inlet of a heat exchanger (310) and from there back to the cell (1),
a secondary circuit (320) at an outlet of the heat exchanger (310),
optionally a primary circuit pump (302), the primary circuit pump (302) producing an adjustable defined dynamic pressure difference of the tempering medium (2) above the cell (1),
optionally a conductivity dosing pump and exchange device (303), the conductivity dosing pump and exchange device (303) drawing off the tempering medium (2) with an adjustable defined conductivity from the primary circuit (300) and replacing it with the tempering medium (2) with an adjustable defined conductivity and thereby optionally producing the adjustable defined static pressure in the primary circuit,
optionally a pH value dosing pump (304), wherein the pH value dosing pump (304) draws off the tempering medium (2) with a defined pH value out of the primary circuit (300) and replaces it with the tempering medium (2) with an adjustable defined pH value and thereby optionally establishes the adjustable defined static pressure in the primary circuit,
optionally a pressure maintaining device (305), wherein the pressure maintaining device (305) maintains the static pressure of the tempering medium (2) in the primary circuit (300) at an adjustable defined value,
a control unit (400), comprising a means for actual value detection (421) of the current efficiency Etaist of the inverter of the inverter wave generator and/or a means for actual value detection (422) the actual value of the current temperature Tetaist of the tempering medium (2) in the primary circuit (300) and a means for specifying (412) the setpoint value for specifying the desired temperature Tetasoll of the temperature of the tempering medium (2) in the primary circuit (300) and/or a means for specifying (411) the setpoint value for specifying the desired efficiency Etasoll of the inverter wave generator.

48. The system for an inverter wave generator according to claim 47,
wherein the control unit (400) in operation detects the current temperature Tetaist of the tempering medium (2) in the primary circuit (300) via the means for actual value detection (422) and/or determines the current efficiency Etaist of the inverter wave generator via the means for actual value detection (421) or from the change in the temperature Tetaist of the tempering medium (2) in the primary circuit (300) shaft generator and the means for setpoint setting (412) for presetting the target temperature Tetasoll of the temperature of the tempering medium (2) in the primary circuit (300), the value of a target temperature Tetasoll of the temperature of the tempering medium (2) in the primary circuit (300) and/or the means for setpoint setting (411) for setting the target efficiency Etasoll of the inverter wave generator, takes the value of a desired efficiency Etasoll and in a controller (410) forms the control deviation (d1) from the difference between the desired value Tetasoll and the actual value Tetaist and/or forms the control deviation (d2) from the difference between the desired value Etasoll and the actual value Etaist and in the controller (410) forms a parameter control signal (p1) and/or a parameter control signal (p2) by means of a controller component (r1) and/or a controller component (r2) with which a controlled system (420) can be controlled in such a way that the control deviation (d1) and/or (d2) successively tends towards zero.

49. The system for an inverter wave generator according to claim 48,
wherein, by means of the controlled system (420), in operation the parameter settings of the function signal generator (220) and/or the optional filter (230) and/or the optional filter (250) and/or the sinus signal generators (221, 221′) and/or of an optional offset source (222) and/or of a mixer (223) and/or of the optional offset source (260) and/or of an amplifier (240) of the signal source (200) and/or of the primary circuit pump (302) and/or of the conductivity dosing pump and exchange device (303) and/or of the pH dosing pump (304) and/or of an electrode actuator (140) and/or of the pressure-maintaining device (305) and/or of a nozzle plate actuator on the basis of the controlling specifications via the parameter control signal (p1) of the controller component (r1) and/or via the parameter control signal (p2) of the controller component (r2) are controllable in such a manner that the control deviation (d1) and/or (d2) successively tends towards zero.

50. The system for an inverter wave generator according to claim 47,
wherein the control unit (400) in an electronic control unit of the inverter wave generator is analog and/or at least partially digital.

51. The system for an inverter wave generator according to claim 47,
wherein the control unit (400) has a self-adaptive function,
wherein the control unit (400), in addition to the properties of the stimulating electrical control signal us(t), controls the properties, in particular the conductivity and/or the flow rate and/or the pressure of the tempering medium (2) and/or the distance of the electrodes (110), (120) and/or the effective opposing electrode area of the electrodes (110), (120) and/or the nozzle area of the nozzles (151) and/or the outlet angle of the nozzles (151), and continuously makes corrections via the parameter control signals (p1) and/or (p2), in that successfully and/or unsuccessfully executed parameter settings and their initial situation are stored in a memory device of the electronic control unit of the inverter wave generator and are selected with higher priority at a later time and optionally stored again if successful.

52. A method of operating an inverter wave generator comprising the steps of:
providing the inverter wave generator according to claim 27,
moving a tempering medium (2) in a primary circuit (300),
thereby supplying the tempering medium (2) in the primary circuit (300) to a cell (1) comprising a first electrode (110) and a second electrode (120),
applying a stimulating electrical control signal us(t) to the electrodes (110, 120) in direct electrical contact with the tempering medium (2),
subjecting the tempering medium (2) in the cell (1) between the electrodes (110, 120) to an electric field which influences the orientation of the particles of the tempering medium (2) in accordance with its polarity and thereby changes the temperature Tetaist of the tempering medium (2) in the primary circuit (300),
feeding the tempering medium (2) in the primary circuit (300) to the inlet of a heat exchanger (310) and in the heat exchanger (310) at least partially releasing thermal energy to the outlet of the heat exchanger (310).
